(19) United States
(12) Patent Application Publication
(10) Pub. No.: US 2024/0343588 A1
(43) Pub. Date: Oct. 17, 2024

(54) PREPARATION OF CROSS-LINKED AEROGELS AND DERIVATIVES THEREOF

(71) Applicant: Aerogel Technologies, LLC, Boston, MA (US)

(72) Inventors: Nicholas Leventis, Rolla, MO (US); Anand G. Sadekar, Rolla, MO (US); Naveen Candrasekaran, Rolla, MO (US); Chariklia Sotiriou-Leventis, Rolla, MO (US)

(73) Assignee: Aerogel Technologies, LLC, Boston, MA (US)

(21) Appl. No.: 18/510,853

(22) Filed: Nov. 16, 2023

Related U.S. Application Data
(63) Continuation of application No. 15/726,483, filed on Oct. 6, 2017, now abandoned.
Application No. 15/726,483 is a continuation of application No. 13/022,511, filed on Feb. 7, 2011, now abandoned.
(60) Provisional application No. 61/302,147, filed on Feb. 7, 2010.

(51) Int. Cl. C01B 32/956; C01B 32/05; C01B 32/90; C01B 32/97; C01B 32/991

(52) U.S. Cl. CPC C01B 32/956; C01B 32/05; C01B 32/90; C01B 32/97; C01B 32/991; Y10T 428/249953

(57) ABSTRACT

Three-dimensional nanoporous aerogels and suitable preparation methods are provided. Nanoporous aerogels may include a carbide material such as a silicon carbide, a metal carbide, or a metalloid carbide. Elemental (e.g., metallic or metalloid) aerogels may also be produced. In some embodiments, a cross-linked aerogel having a conformal coating on a sol-gel material is processed to form a carbide aerogel, metal aerogel, or metalloid aerogel. A three-dimensional nanoporous network may include a free radical initiator that reacts with a cross-linking agent to form the cross-linked aerogel. The cross-linked aerogel may be chemically aromatized and chemically carbonized to form a carbon-coated aerogel. The carbon-coated aerogel may be suitably processed to undergo a carbothermal reduction, yielding an aerogel where oxygen is chemically extracted. Residual carbon remaining on the surface of the aerogel may be removed via an appropriate cleaning treatment.

### RELATED APPLICATIONS

This application is a continuation of U.S. patent application Ser. No. 15/726,483, filed Oct. 6, 2017, and entitled “Preparation of Cross-Linked Aerogels and Derivatives Thereof,” which is a continuation of U.S. patent application Ser. No. 13/022,511, filed Feb. 7, 2011, and entitled “Preparation of Cross-Linked Aerogels and Derivatives Thereof,” which claims the benefit of U.S. Provisional Patent Application No. 61/302,147, filed Feb. 7, 2010, and entitled “Click Synthesis of Monolithic Silicon Carbide Aerogels from Polyacrylonitrile-Coated 3D Silica Networks,” each of which is incorporated herein by reference in its entirety for all purposes.

### FEDERALLY SPONSORED RESEARCH

This invention was made with government support under Grant Numbers CHE-0809562 and CMMI-0653919 awarded by the National Science Foundation. The government has certain rights in the invention.

### BACKGROUND

### 1. Field

Aspects herein generally relate to three-dimensional nanoporous networks, uses thereof, and methods of preparation. For example, three-dimensional nanoporous networks may include a carbide material.

### 2. Discussion of Related Art

Aerogels are quasi-stable three-dimensional assemblies of nanoscale, nanostructured, or nanofeatured particles that are highly porous materials exhibiting ultra-low densities. Aerogel materials are typically produced by forming a gel containing a liquid component and a porous solid component and removing the liquid to leave behind the porous solid by supercritically or subcritically drying the wet gel.

Supercritical drying involves the solvent being transformed into a vapor above its critical point, and allowing the vapor to escape while leaving the porous solid structure intact. The large internal void space in aerogels generally provides for a material with low dielectric constant, low thermal conductivity, and high acoustic impedance. Aerogels have been considered for a number of applications including thermal insulation, lightweight structures, and impact resistance.

Silicon carbide is a semiconductor material with a generally high band gap and high impact absorption properties.

### SUMMARY

Three-dimensional porous carbide networks and methods for their preparation are described. Aspects discussed herein may generally relate to three-dimensional nanoporous materials that include a carbide material, although a carbide material is not required. The carbide material may be. for example, a silicon carbide, a metal carbide, or a metalloid carbide. In some cases, the three-dimensional porous material may be metallic in chemical composition. In some cases, the three-dimensional porous network may include an aerogel.

In some embodiments, aspects described herein relate to a cross-linked aerogel. The cross-linked aerogel may include a porous three-dimensional network of interconnected particles or structures where a cross-linking agent is provided to conformally coat the porous three-dimensional network (e.g., sol-gel material). Examples of cross-linking agents that are applied as a conformal coating to a porous three-dimensional network for forming a cross-linked aerogel include acrylonitrile and polyacrylonitrile, isocyanate-terminated molecules with generally high aromatic character, and other molecules that are carbonizable, that is, a substantial of the non-carbon components of the polymer can be chemically removed from the overall molecular structure while retaining carbon atoms. Once formed, a cross-linked aerogel comprising a porous three-dimensional network (e.g., sol-gel material) having a conformal coating may be further processed to form a carbide aerogel, or alternatively, a metal aerogel. In some embodiments, a porous three-dimensional network includes a free radical initiator material. A free radical (e.g., a free radical electron) of the free radical initiator material may react with a cross-linking agent to form a conformal coating on the porous three-dimensional network.

In some embodiments, aspects described herein relate to a carbon-coated aerogel. The carbon-coated aerogel may include a porous three-dimensional network where a plurality of non-aromatic or aromatic carbon ring structures are provided as a layer that conformally coats the porous three-dimensional network (e.g., sol-gel material).

In some embodiments, aspects described herein relate to an oxidized polyacrylonitrile-coated aerogel. The oxidized polyacrylonitrile-coated aerogel may include a porous three-dimensional network (e.g., sol-gel material) where a plurality of non-aromatic or aromatic carbon ring structures are provided as a layer that conformally coats the porous three-dimensional network.

Aspects described herein may relate to a method of preparing an aerogel. A cross-linking agent may be applied to a network (e.g., sol-gel material) to form a coating on the network. The coating may be conformal in nature and may result in a surface layer of a material over surfaces of the network. The coating on the network may be treated to form a plurality of ring structures (e.g., aromatic or non-aromatic) within the coating on the network. The plurality of ring structures within the coating on the network may be further treated to form a plurality of carbon ring structures within the coating on the network. The plurality of carbon ring structures within the coating on the network may be involved in a chemical reaction to form the aerogel. In some cases, underlying backbone of the network may be chemically reduced by carbon atoms in the carbon-coating. Residual carbon that may remain unreacted on surfaces of the aerogel may be optionally removed through a cleaning process.

In an illustrative embodiment, a three-dimensional porous material is provided. The three-dimensional nanoporous material includes a carbide material.

In another illustrative embodiment, a method of preparing a three-dimensional nanoporous material is provided. The method includes forming a porous precursor material; applying a cross-linking agent to the porous precursor material to form a coating on the porous precursor material; treating the coating on the porous precursor material to form a plurality of ring structures within the coating on the sol-gel material; treating the plurality of ring structures within the coating on the porous precursor material to form a plurality of carbon ring structures within the coating on the porous precursor material; and chemically reacting the plurality of carbon ring structures within the coating with the underlying porous precursor material to form the three-dimensional nanoporous material.

In a different illustrative embodiment, a method of preparing a cross-linked porous three-dimensional network is provided. The method includes forming a porous three-dimensional network including a free radical initiator; and reacting a free radical of the free radical initiator with a cross-linking agent to form a conformal coating on the porous three-dimensional network.

In a further illustrative embodiment, a method of preparing an aerogel product is provided. The method includes forming a conformal coating on a porous three-dimensional porous precursormaterial to form a cross-linked aerogel; and processing the cross-linked aerogel to form the aerogel product.

In yet another illustrative embodiment, an aerogel is provided. The aerogel includes a porous three-dimensional porous precursor material; and a cross-linking agent conformally coating the porous three-dimensional porous precursor material, wherein the cross-linking agent includes a carbonizable polymer. In some cases, the aerogel may be a cross-linked aerogel, or an oxidized cross-linked aerogel.

In a different illustrative embodiment, a carbon-coated aerogel is provided. The carbon-coated aerogel includes a porous three-dimensional porous precursor material; and a plurality of aromatic carbon ring structures conformally coating the porous three-dimensional porous precursor material.

In a further illustrative embodiment, method of preparing a metallic aerogel is provided. The method includes forming a conformal coating on a porous three-dimensional network material to form a cross-linked aerogel; and processing the cross-linked aerogel to form the metallic aerogel.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF DRAWINGS

The accompanying drawings are not intended to be drawn to scale. For purposes of clarity, not every component may be labelled in every drawing. In the drawings:

FIG. 1 depicts scanning electron micrographs (SEM) of silica aerogels cross-linked with polyacrylonitrile in accordance with examples presented herein: (A) as prepared; (B) after an aromatization process; and (C) after a carbonization process;

FIG. 2 illustrates nitrogen sorption isotherms of silica aerogel samples cross-linked with polyacrylonitrile in accordance with examples presented herein: (A) as prepared; (B) after aromatization and carbonization: (C) after carbothermal treatment followed by oxidative cleaning; and (D) after further carbothermal reduction treatment followed by oxidative cleaning;

FIG. 3 depicts differential scanning calorimetry (DSC) data of an aerogel in accordance with examples presented herein;

FIG. 4 illustrates nuclear magnetic resonance (NMR) data of aerogels processed in accordance with examples presented herein;

FIG. 5 depicts correlation of the C: SiO₂ mol ratio after aromatization and carbonization with the initial acrylonitrile: total Si mol ratio in formulations listed in Table 1 in accordance with examples presented herein;

FIG. 6 depicts x-ray diffraction (XRD) data for samples in accordance with examples presented herein after carbothermal reduction treatment at various temperatures followed by oxidative removal of unreacted carbon.

FIG. 7 illustrates NMR data for samples in accordance with examples presented herein of: (A) a mixture of commercial SiC and silica; (B) a sample treated carbothermally; (C) a different sample treated carbothermally, followed by heat treatment; and (D) another sample treated carbothermally, followed by heat treatment;

FIG. 8 depicts SEM micrographs of samples treated carbothermally at various temperatures in accordance with examples presented herein where the left column shows samples before oxidative cleaning and the right column shows samples after removal of unreacted carbon;

FIG. 9 depicts SEM micrographs of more samples treated carbothermally in accordance with examples presented herein where the left column shows samples before oxidative cleaning and the right column shows samples after removal of unreacted carbon;

FIG. 10 illustrates photographs of a cross-linked silica aerogel monolith (on the left) and of a resulting SiC aerogel monolith (on the right) after aromatization, carbothermal reduction, and oxidative removal of unreacted carbon in accordance with embodiments described herein;

FIG. 11 is a schematic illustration of carbothermal processes at the interface of silica and carbon according to some embodiments described herein;

FIG. 12 is a schematic illustration of processes at the interface of silica and a newly formed silicon carbide according to some embodiments described herein;

FIG. 13 shows SEM micrographs of a sample of a cross-linked silica aerogel cross-linked with Desmodur RE in accordance with embodiments described herein;

FIG. 14 illustrates nitrogen sorption isotherms of a sample of a cross-linked silica aerogel cross-linked with Desmodur RE in accordance with embodiments described herein;

FIG. 15 shows SEM micrographs of a sample of a silicon carbide aerogel resulting from a cross-linked silica aerogel cross-linked with Desmodur RE having been pyrolyzed under inert atmosphere at 1500 C prior to removal of unreacted carbon in accordance with embodiments described herein;

FIG. 16 depicts nitrogen sorption isotherms of a sample of an aerogel resulting from a cross-linked silica aerogel cross-linked with Desmodur RE having been processed under inert atmosphere at 800 C in accordance with embodiments described herein;

FIG. 17 depicts SEM micrographs of a sample of an aerogel resulting from a cross-linked silica aerogel cross-linked with Desmodur RE having been pyrolyzed under inert atmosphere at 800 C in accordance with embodiments described herein;

FIG. 18 shows SEM micrographs of a sample of a silicon carbide aerogel resulting from a cross-linked silica aerogel cross-linked with Desmodur RE having been pyrolyzed under inert atmosphere at 1500 C after removal of unreacted carbon in accordance with embodiments described herein;

FIG. 19 illustrates nitrogen sorption isotherms of a sample of a silicon carbide aerogel resulting from a cross-linked silica aerogel cross-linked with Desmodur RE processed at 1500 C after removal of unreacted carbon in accordance with embodiments described herein;

FIG. 20 depicts XRD data for a silicon carbide aerogel prepared from sample of a cross-linked silica aerogel having been pyrolyzed under inert atmosphere at 1500 C in accordance with examples presented herein;

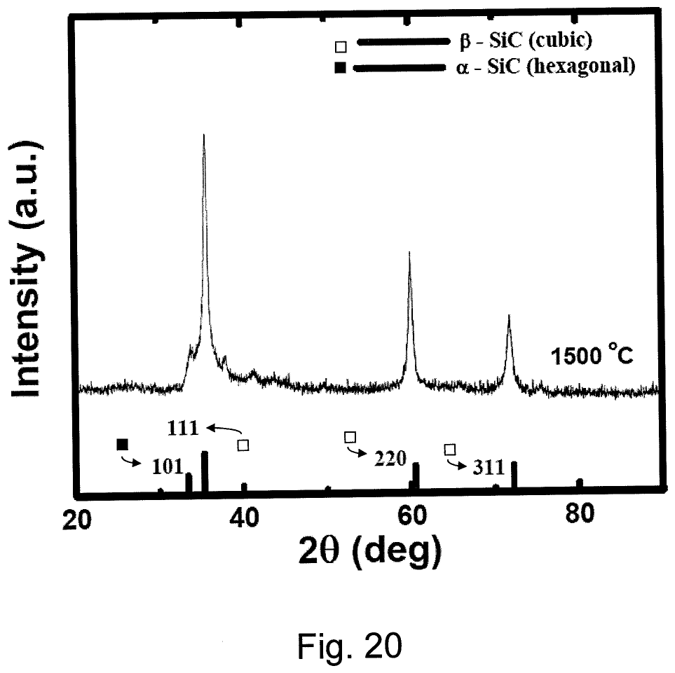

FIG. 21 shows SEM micrographs of a sample of a cross-linked iron oxide aerogel (cross-linked with TMT) before and after pyrolysis under inert atmosphere at 800 C in accordance with embodiments described herein;

FIG. 22 illustrates nitrogen sorption isotherms of a sample of a cross-linked iron oxide aerogel (cross-linked with TMT) in accordance with embodiments described herein;

FIG. 23 depicts nitrogen sorption isotherms of sample of a cross-linked iron oxide aerogel (cross-linked with TMT) having been processed under inert atmosphere at 800 C in accordance with embodiments described herein;

FIG. 24 shows XRD data for a sample of a mixed iron/iron carbide aerogel resulting from a cross-linked iron oxide aerogel cross-linked with TMT having been pyrolyzed under inert atmosphere at 800 C in accordance with examples presented herein;

FIG. 25 shows SEM micrographs of a sample of a cross-linked nickel oxide aerogel (cross-linked with TMT) before and after pyrolysis under inert atmosphere at 800 C in accordance with embodiments described herein;

FIG. 26 illustrates nitrogen sorption isotherms of a sample of a cross-linked nickel oxide aerogel (cross-linked with TMT) in accordance with embodiments described herein;

FIG. 27 depicts nitrogen sorption isotherms of a sample of a cross-linked nickel oxide aerogel cross-linked with TMT having been processed under inert atmosphere at 800 C in accordance with embodiments described herein;

FIG. 28 shows XRD data for a sample of a nickel aerogel resulting from a cross-linked nickel oxide aerogel cross-linked with TMT having been pyrolyzed under inert atmosphere at 800 C in accordance with examples presented herein;

FIG. 29 shows SEM micrographs of a sample of a cross-linked tin oxide aerogel cross-linked with TMT in accordance with embodiments described herein;

FIG. 30 depicts SEM micrographs of a sample of a cross-linked tin oxide aerogel cross-linked with TMT having been pyrolyzed under inert atmosphere at 800 C in accordance with embodiments described herein;

FIG. 31 illustrates nitrogen sorption isotherms of a sample of a cross-linked tin oxide aerogel cross-linked with TMT in accordance with embodiments described herein;

FIG. 32 depicts nitrogen sorption isotherms of a sample of a cross-linked tin oxide aerogel cross-linked with TMT having been processed at 800 C in accordance with embodiments described herein;

FIG. 33 shows XRD data for a sample of a tin aerogel resulting from a cross-linked tin oxide aerogel crosslinked with TMT having been pyrolyzed under inert atmosphere at 800 C in accordance with examples presented herein;

FIG. 34 shows SEM micrographs of a sample of a cross-linked vanadium oxide aerogel cross-linked with TMT in accordance with embodiments described herein;

FIG. 35 depicts SEM micrographs of a sample of a cross-linked vanadium oxide aerogel cross-linked with TMT having been pyrolyzed under inert atmosphere at 800 C in accordance with embodiments described herein and XRD data from a sample of vanadium carbide aerogel resulting from said cross-linked vanadium oxide aerogel;

FIG. 36 illustrates nitrogen sorption isotherms of a sample of a cross-linked vanadium oxide aerogel cross-linked with TMT in accordance with embodiments described herein; and

FIG. 37 depicts nitrogen sorption isotherms of a sample of a cross-linked vanadium oxide aerogel cross-linked with TMT having been processed under inert atmosphere at 800 C in accordance with embodiments described herein.

### DETAILED DESCRIPTION

Aspects described herein relate to three-dimensional nanoporous networks and methods for preparing the networks. In particular, silicon carbide (SiC), metal carbide and metalloid carbide aerogels are disclosed along with various methods for preparing such materials. In addition, metal and metalloid aerogels and methods for their preparation are also described.

A cross-linked aerogel may include a three-dimensional nanoporous material (e.g., a sol-gel material) that is conformally coated with a cross-linking agent. In some embodiments, the nanoporous material includes an oxide, a chalcogenide, a nitride, or a phosphide. The cross-linking agent may be chemically bound and/or adsorbed to surfaces of the underlying nanoporous material. In various embodiments described below, a three-dimensional nanoporous material may or may not include a free radical initiator. In turn, a cross-linking agent that conformally coats the three-dimensional nanoporous material may include a material that reacts with the free radical initiator. Accordingly, a free radical (e.g., a free radical electron) of the free radical initiator may react with the cross-linking agent to form the conformal coating on the three-dimensional nanoporous material. In some embodiments, the cross-linking agent includes polyacrylonitrile (PAN). However, other cross-linking agents may be used, including cross-linking agents that are non radical-mediated cross-linkers. In some cases. the cross-linking agent may be carbonizable where non-carbon atoms are chemically removed while retaining carbon atoms in the overall structure. In some embodiments, a free radical initiator of the nanoporous network includes (4,4′-(diazene-1,2-diyl) bis-(4-cyano-N-(3-triethoxysilyl) propyl) pentanamide) (Si-AIBN). Though, the nanoporous network is not required to include a free radical initiator. The cross-linked aerogel including the three-dimensional nanoporous material having a conformal coating may be further processed to form an aerogel comprising a carbide material. and/or a metallic aerogel.

In some embodiments, a carbon-coated aerogel may be prepared. The carbon-coated aerogel may include a three-dimensional nanoporous material (e.g., a sol-gel material) that is conformally coated with carbon. In some cases, such a carbon coating may be formed as a plurality of aromatic carbon ring structures similar to graphite.

In some embodiments, a cross-linked aerogel including a three-dimensional nanoporous network (e.g., a sol-gel material) conformally coated with a cross-linking agent is prepared and further processed to form a different type of aerogel. The conformal coating on the three-dimensional nanoporous network may be treated (e.g., heat treatment in air) in a process (e.g., an aromatization process) to form a plurality of ring structures (e.g., aromatic or non-aromatic) within the coating on the three-dimensional nanoporous network. The plurality of ring structures within the coating on the three-dimensional nanoporous network may be further treated (e.g., heat treatment at higher temperatures and in an inert atmosphere) to form a plurality of carbon ring structures (e.g., aromatic or non-aromatic) within the coating on the three-dimensional nanoporous network. The plurality of carbon ring structures within the coating on the three-dimensional nanoporous network may then be chemically reacted (e.g., heat treatment at even higher temperatures and also in an inert atmosphere) with atoms on the nanoporous network resulting in the chemical removal of atoms (e.g., oxygen atoms) from the three-dimensional nanoporous network. In some cases, carbon from within the coating may function to chemically reduce portions of the nanoporous network. It can be appreciated that ring structures described herein may be aromatic or non-aromatic. For example, oxygen atoms may be chemically extracted while the morphology of the three-dimensional nanoporous network remains generally intact. In some instances, atoms (e.g., oxygen atoms) may be chemically replaced with carbon atoms, giving rise to a three-dimensional nanoporous aerogel including a carbide material (e.g., silicon carbide, metal carbide, metalloid carbide. etc.). Accordingly, a carbide aerogel may be produced. In some cases, atoms (e.g., oxygen atoms) are chemically removed from the underlying nanoporous material, resulting in the formation of an elemental aerogel (e.g., silicon aerogel, metal aerogel, metalloid aerogel, etc.). Notably, silicon carbide is generally difficult to synthesize as a porous material in a coherent monolithic form. Other metal and metalloid carbides are similarly difficult to render into a porous coherent monolithic form.

In various embodiments, an aerogel may include an open non-fluid colloidal network or polymer network the pores of which may be expanded throughout its volume by a gas. and may be formed by the removal of swelling agents from a gel without substantial volume reduction or network compaction. Aerogels frequently possess significant mesoporosity, that is, pore sizes ranging from 2 to 50 nm in diameter. However, aerogels may also contain significant microporosity (pore sizes less than 2 nm in diameter) and macroporosity (pore sizes larger than 50 nm in diameter) including micron-range pores as well. Aerogels and other aerogel-like three-dimensional networks may possess pore structures containing pores with diameters that fall over a wider range than materials traditionally considered mesoporous. As such, to more conveniently describe the pore features exhibited by a variety of aerogel and three-dimensional networks of interest, in some cases, the term “nanoporous” may refer to materials with a substantial population of pores less than about 10 microns in diameter and typically less than about 1000 nm in diameter, which includes most materials commonly referred to as aerogels and related sol-gel-derived networks.

A cross-linked aerogel (e.g., a PAN cross-linked aerogel) may be prepared by creating a sol-gel material that is conformally coated with a cross-linking agent. Cross-linked aerogels where a three-dimensional nanoporous network is conformally coated and methods for their preparation similar to those generally described in U.S. Pat. No. 7,771,609 entitled “Methods and Compositions for Preparing Silica Aerogels” may be used for producing cross-linked aerogels in accordance with aspects of embodiments described herein. Though, it can be appreciated that other methods may also be used to prepare cross-linked aerogels where a conformal coating is provided on a three-dimensional nanoporous network.

In embodiments provided herein, a cross-linked aerogel may be subject to further process steps to form a different type of aerogel. The cross-linked aerogel may be subject to a step of chemical aromatization and, then. subject to a step of chemical carbonization, producing a carbon-coated aerogel. In some embodiments, the carbon-coated aerogel may include carbon in an amount of greater than 75% by weight of the carbon coating. Or, the carbon coating of the carbon-coated aerogel may include carbon in an amount of greater than 80% by weight, greater than 90% by weight, or greater than 95% by weight of the coating.

The carbon-coated aerogel may then undergo a carbothermal reduction process where atoms such as oxygen are chemically removed from the nanoporous network and a different kind of aerogel is formed, for example, a SiC aerogel. The aerogel having been subjected to the carbothermal reduction process may have a layer of unreacted carbon disposed as residue on the surface of the aerogel. Accordingly, the aerogel may then be further processed to remove the layer of unreacted carbon, yielding an aerogel having a cleaner surface without the layer of unreacted carbon residue.

A variety of suitable precursors may be used for embodiments of methods described herein. Examples of precursors may include Si-AIBN, acrylonitrile (AN), CH₃OH, H₂O, NH₄OH, tetrahydrofuran, ethanol, acetonitrile, a suitable alkoxysilane such as tetramethoxysilane (TMOS) or 3-aminopropyltriethoxysilane, or any other appropriate chemical compound. Precursors may be mixed together in a solution to form a sol. After a suitable period of time (e.g., 10-15 minutes), the sol may gradually evolve into a sol-gel material containing both a liquid phase and solid phase where the morphologies of each phase may include discrete particles and/or continuous polymer networks.

The sol-gel material may be further processed into a cross-linked aerogel, for example, by exposure to heat and/or light, washing with a suitable solvent and/or subjecting to supercritical drying to yield a cross-linked aerogel. In some embodiments, a cross-linking agent (e.g., AN or PAN) may be applied to the sol-gel material and subsequently exposed to light for at least 60 seconds (e.g., about 300 seconds). Alternatively. or in addition, the cross-linking agent may be applied to the sol-gel material and heated at an environment where the temperature is at least 50 C (e.g., about 55 C) for at least 6 hours (e.g., about 12 hours). In some cases. suitable exposure to a sufficient amount of heat and/or light initiates a reaction between the sol-gel material and the cross-linking agent where the cross-linking agent forms a chemical bond with surfaces of the sol-gel material. As a result, the cross-linking agent chemically bound to surfaces of the sol-gel material forms a conformal coating on the sol-gel material. In some embodiments, the conformally coated sol-gel material is washed with a suitable solvent, such as for example, ethanol or toluene. Although not required, the conformally coated sol-gel material may be dried. Drying may occur through any suitable process, for example, supercritical drying (e.g., with supercritical carbon dioxide), subcritical drying or ambient drying (e.g., in air).

The coating on the sol-gel material of the cross-linked aerogel may be further processed. In some embodiments, the cross-linked aerogel is treated so that the coating on the sol-gel material is chemically processed into a plurality of ring structures. For example. the sol-gel material may be chemically aromatized to result in a plurality of aromatic ring structures. Such a treatment may include, for example, exposing the cross-linked aerogel to an environment having a temperature of between about 100 C and about 500 C in air for at least 12 hours (e.g., a temperature of about 225 C for about 36 hours).

The aerogel having the processed coating may be further processed to chemically carbonize the coating into a plurality of carbon ring structures, such as structures similar to graphite. In some cases, carbon ring structures may be aromatic or non-aromatic. Aromatic carbon ring structures may be structurally similar to graphite. This chemical carbonization treatment may include further exposing the aerogel to an environment having a temperature of between about 200 C and about 1000 C in an inert atmosphere for at least 1 hour (e.g., a temperature of about 300 C for about 3 hours). As a result, the conformal coating on the aerogel includes a predominantly carbon structure that, in some cases, may resemble graphite. In some cases, when a chemically processed coating (e.g., chemically aromatized coating) network is heated according to the above temperatures in inert atmosphere, during chemical carbonization, a variety of gas species may evolve. For example, carbon monoxide, carbon dioxide and cyanide may arise during the carbonization process.

Moreover, the aerogel having the chemically carbonized aromatic coating may be subsequently processed so as to undergo a carbothermal reduction process. In some embodiments, the carbothermal reduction process chemically removes oxygen from the underlying sol-gel material. For example, in a carbon-coated silica aerogel, a carbothermal reduction will effectively extract oxygen from the chemical composition of the nanoporous silica network to form a nanoporous silicon network or a nanoporous silicon carbide network. In some cases, carbon may also be volatized from the nanoporous network in the form of carbon monoxide and/or carbon dioxide. The morphology of the nanoporous network where oxygen is chemically removed may be substantially similar to the previous nanoporous network where oxygen had been previously incorporated. A carbothermal reduction process may involve exposing the aerogel material to an environment having a temperature of between about 500 C and about 2000 C in an inert atmosphere (e.g., a temperature of between about 1200 C and about 1600 C). As a result of the carbothermal reduction, the chemical makeup of the three-dimensional nanoporous network is fundamentally altered.

Depending on the processing conditions of the carbothermal reduction, an elemental aerogel, a carbide aerogel or a combination thereof may arise. In some embodiments, the amount of carbon present in the system (e.g., carbon coating) may influence whether an elemental aerogel or a carbide aerogel is formed. For example, a carbon-coated aerogel having a densely thick conformal carbon coating subject to a carbothermal reduction process may result in the formation of a carbide aerogel. In such a case, a carbon-coated silica aerogel may undergo carbothermal reduction where the abundance of carbon within the coating forms a chemical bond with the silicon atoms within the nanoporous network to yield a SiC aerogel. Conversely, a carbon-coated aerogel (e.g., carbon-coated silica aerogel) only having a sparse conformal carbon coating that undergoes carbothermal reduction may give rise to an elemental aerogel, such as a silicon aerogel, or alternatively, a metal or metalloid aerogel. In such a case, the lack of carbon merely results in the removal of oxygen from the chemical composition of the nanoporous aerogel. Indeed, for cross-linked metal or metalloid oxide aerogels, the above described processes may provide a suitable path for preparing a metal aerogel or a metalloid aerogel.

It can be appreciated that atoms other than oxygen can be removed from a non-oxide based nanoporous network (e.g., non-oxide aerogel). For example, sulfur atoms may be removed from a sulfide-based nanoporous network, such as in a metal sulfide aerogel or a metalloid sulfide aerogel.

Once atoms (such as oxygen) have been chemically removed in a suitable manner from the nanoporous network, optionally, the surface of the aerogel may be appropriately cleaned. For example, an amount of unreacted carbon may remain on the surface of the aerogel as residue. An appropriate treatment step may be performed to remove such carbon residue. In some embodiments, the aerogel is heated in an environment having a temperature greater than about 300 C in air (e.g., a temperature of about 600 C). A cleaning step removing excess carbon from the surface of the aerogel may involve applying a cleaning agent (e.g., carbon monoxide, carbon dioxide, oxygen, water, ammonia, and/or an oxidizing agent) to the surface of the aerogel.

In some embodiments, heating steps described above may occur in a single chamber where the environment can be controlled. As such, monolithic highly porous (e.g., 70% v/v) SiC aerogels may be synthesized using a pyrolytic (e.g., carbothermal reduction, carbonization) process where silica aerogels are previously prepared and coated in a single reaction vessel with a conformal coating (e.g., PAN, isocyanate) via a surface-initiated free radical process. In some cases, the chamber may be programmable where the temperature, the atmosphere (e.g., inert, air, with an oxidizing gas, or with a reducing gas), the time of exposure and any other suitable processing parameter(s) may be automatically entered into a controller so that suitable aerogels described herein may be produced. For example, an environmental chamber may be coupled with a controller such that the temperature and atmospheric environment may be automatically set. As such, for example, a PAN-crosslinked silica aerogel may be created in or placed in such a chamber, a user may set the chamber to process the PAN-crosslinked silica aerogel according to a series of automated treatments, and the user may activate the system to proceed, without any further effort. Once the series of process steps are completed, the PAN-crosslinked silica aerogel may, for example, be effectively transformed into an oxidized PAN coated aerogel, a carbon-coated aerogel, or a SiC aerogel. It can be appreciated that such a process can be employed for cross-linked aerogels other than PAN-crosslinked silica aerogels.

During suitable processes of chemical processing of the coating including, for example, chemical aromatization, chemical carbonization and carbothermal reduction. starting from a cross-linked aerogel, the morphology of the underlying three-dimensional nanoporous structure may remain generally the same. In some cases, an amount of sintering and/or change in particle size, pore volume, pore size, density and/or volume may occur, though, the overall morphology is not drastically altered.

Although not required, in some embodiments, a three-dimensional nanoporous material is formed from a free radical initiator. As described above, a free radical electron of the free radical initiator may react with a cross-linking agent in a solution to form the conformal coating chemically bound and/or adsorbed on surfaces of the three-dimensional nanoporous material. Any suitable free radical initiator may be used. In some embodiments, without limitation, the free radical initiator includes Si-AIBN. In some embodiments, the free radical initiator may include, for example, a peroxide initiator, an organic peroxide initiator, an azo initiator, a halogen initiator, a trialkoxysilane, an amine or any other suitable initiator compound. A monodentate surface-confined initiator may also be used. As an example, a suitable conformal coating may be obtained by engaging surface-confined acrylates via homogeneous thermal or photo-polymerization of AN in the pores (e.g., mesopores) of the nanoporous network.

Any suitable cross-linking agent may be used. In some embodiments, a cross-linking agent may include a free radical initiated crosslinker, such as AN or PAN. Other cross-linking agents that may or may not be free radical initiated may include polyisocyanate, polystyrene, polymethylmethacrylate, polyurethane, polyurea, polyimide, polybenzoxanines, polynorbornenes, divinyl benzene, derivatives thereof, or the like. In some embodiments, a cross-linking agent may include an isocyanate such as Desmodur N3300A. Desmodur N3200, Desmodur RE, Mondur CD (MDI), Mondur TD (TDI). triphenylmethane-4.4′,4″-triisocyanate (TMT), or the like.

As discussed, embodiments of methods described herein may be used for compounds other than silica. Indeed, cross-linked metal oxide. metalloid oxide or non-oxide aerogels may be subject to suitable chemical processed including chemical aromatization, chemical carbonization and/or carbothermal reduction to form a metal aerogel or a metalloid aerogel. For example, a cross-linked iron oxide aerogel having a conformal coating may be subject to the above processes resulting in an iron aerogel and/or an iron carbide aerogel. Other metals or metalloids may be suitable. For example, cross-linked aerogels including a nanoporous network of iron oxide. vanadium oxide, tin oxide, nickel oxide, boron oxide, or any other suitable metal or metalloid oxide or combinations/mixtures thereof, may be processed according to embodiments described herein to yield aerogels including a nanoporous network of iron, iron carbide, vanadium, vanadium carbide, tin, tin carbide, nickel, nickel carbide, boron, boron carbide or any other suitable metal or metalloid, or metal carbide or metalloid carbide. It can be appreciated that embodiments of nanoporous network materials described herein may refer to oxides, non-oxides and/or combinations/mixtures thereof.

Embodiments described herein may provide a number of benefits. In some cases, SiC aerogels may be incorporated in any suitable advanced fiber-reinforced SiC composite. For example, SiC aerogels may be used in combination with carbon fibers, silicon carbide fibers. boron fibers, alumina fibers, glass fibers. basalt fibers or other suitable fibrous materials. In some instances, fibrous materials may be incorporated within a carbide aerogel and the carbide aerogel may be filled with a matrix such as carbon (e.g., from chemical vapor deposition, chemical vapor infiltration and/or pyrolysis of propylene or acetylene), silicon carbide. phenolic resin, epoxy or another appropriate material.

In some cases, embodiments of aerogels described herein may be useful for several types of applications. For example, such aerogels may be used for high-temperature resistance applications, such as for tribological applications including those that incorporate brake discs, clutch discs, engine parts or other devices involving moving components. Aerogels provided herein may be used as a substrate for high-temperature heterogeneous catalysis, or as an oxygen-resistant substrate for high-temperature applications. Such aerogels may be used for number of mechanical and/or temperature related applications as well, for example, those applications that involve high-temperature insulation (e.g., as a thermal reentry material), light weight materials, heat sinks, cellular metallic foams, sandwich structures, armor, impact dampening, nuclear fuel matrices or any other appropriate application. Aerogels described herein are also contemplated for use in a variety of electromagnetic and/or electrochemical applications, such as those that involve high surface area for apparatuses including electrodes. capacitors, batteries. desalination devices or other suitable devices. Aerogels described herein are further contemplated for use in solid state electronics and power electronics, including high-temperature solid state electronics, solid state relays, and lasers.

Embodiments of the overall methods described herein may be effective for processes within a conformally coated silica framework. Additionally, methods involving a one pot synthesis of a PAN-crosslinked silica framework may be advantageous over previous works of polymer crosslinked aerogels where crosslinking agents are introduced post-gelation by solvent exchanges, which may, at times, be time-consuming. In some embodiments, methods for synthesizing crosslinked silica frameworks (e.g., PAN crosslinks and/or other polymer crosslinks) may involve post-crosslinking washes, though not being necessary requirements thereof. Where processes occur within a conformally coated skeletal framework, post-crosslinking removal of loose (i.e., chemically unincorporated) crosslinking agents (e.g., PAN or other suitable crosslinking agents) may be circumvented in a final cleaning step. For example, carbon formed in the mesopores may be removed from the final aerogel product via heating and/or oxidation. As mechanically strong polymer crosslinked aerogels can be made through ambient pressure drying, SCF CO₂ drying also might not be necessary.

### EXAMPLES

The following examples are only provided as illustrative embodiments of the present invention and are meant to be non-limiting. As follows, SiC aerogels may be prepared using suitable methods described below. However, other aerogels, such as metal carbide, metalloid carbide, metal, and metalloid aerogels, including aerogels in which one or more of the group of metal carbides, metalloid carbides, metals, and metalloids are simultaneously present, may also be suitably prepared.

SiC is a generally bioinert large band-gap semiconductor (e.g., 2.36 eV and 3.05 eV for β-and α-SiC, respectively) which combines hardness (9 to 9.5 on the Mohs scale), high thermal conductivity (120 W m⁻¹ K⁻¹), low thermal expansion coefficient (4×10⁻⁶° C.⁻¹), good thermal shock resistance, high mechanical strength/oxidation resistance at high temperatures) (>1500° and is a viable candidate for replacing silica, alumina, and carbon as supports for catalysts.

Monolithic porous SiC can be prepared by sintering powders, which are synthesized economically by carbothermal reduction of silica with carbon according to equation (1) as follows:

$${SiO}_{2} + 3 C SiC + 2 CO \qquad ( 1 )$$

However, because of the high covalent character and strength of the sp³-sp³ C—Si bonds, SiC itself, in some cases, is a difficult material to sinter. As a result, sintering is carried out reactively, usually with sintering aids (e.g., alumina, carbon). Oxidation bonding, wherein SiC compacts are heated at 1100-1500° C. in air, can be considered as a simple version of reactive sintering; porosities of up to 30% may be achieved by including sacrificial (oxidizable) graphite in the compacts. Furthermore, the resulting material is not substantially nanoporous.

Porous SiC may be obtained by shape-memory-synthesis (SMS) wherein the product of equation (1) mimics the shape of the carbon source. As will be discussed later, equation (1) may involve a process that starts with generation of SiO gas and CO at the SiO₂/C interface. SiC may be a primary result of the gas-solid reaction between SiO g) and C(s). Thus, SMS of porous SiC may be carried out initially with SiO(g) generated independently (e.g., by reacting Si and SiO₂) and porous carbon from various sources. Since natural materials are renewable and relatively inexpensive. SMS-conversion of biomorphic carbon (charcoal) to SiC that retains the hierarchical porous structure of the parent wood may be implemented. More economic alternatives include infiltration of charcoal with silica sol, and ultimately direct infiltration of a charcoal precursor (wood) with sodium silicate, thus eliminating even the pyrolysis step of converting wood to charcoal as that takes place in situ along the way of setting off the carbothermal process of equation (1). Typical surface areas for biomorphic SiC are about 14 m²g⁻¹. The methodology of using charcoal as a structure directing agent may be extended to artificial porous graphitic substrates. A challenge in using silica sols is in providing multi-infiltrations to bring the C:SiO₂ ratio at the stoichiometry of equation (1).

Carbon-or carbon-precursor doped silica aerogels and cross-linked aerogels may be employed as SiC precursors due to their high surface area which increases the contact between the two solid-state reactants of equation (1). In some instances, however, the resulting SiC is more whisker-like than particulate. Whiskers may be formed via a gas-phase reaction between the SiO(g), as shown in equation (2) and CO(g) intermediates of equation (1). Equation (2) is provided as follows:

$$SiO ( g ) + 3 CO ( g ) SiC ( s ) + 2 {CO}_{2} ( g ) \qquad ( 2 )$$

The porous architecture of C-doped sol-gel networks may facilitate retention and circulation of the above gases long enough to promote equation (2) with loss of memory of the shape of the silicon and carbon sources. In some cases, formation of whiskers may create a health hazard. Therefore, to take advantage, mimic and maintain the monolithicity and microstructure of silica aerogels. SiO₂ may be encapsulated within a carbon precursor, ensuring that SiO(g) generated at the interface of SiO₂ and C will pass through and react with carbon. Cross-linked silica aerogels are an example of such a route for performing this reaction without, for example, loss of memory of the shape and/or whisker formation.

In coating silica with carbon, fumed silica powder (e.g., Carbosil, 10 nm in diameter) may be coated with pyrolytic carbon by multiple exposures to a static propylene atmosphere at 600° C., followed by pyrolytic conversion to SiC at 1300-1600° C. under flowing Ar. Comparison of simple mixtures of Carbosil with carbon black reveals that more carbon remains unreacted in the mixed (e.g., ˜10% w/w) rather than in the coated systems (e.g., 5% w/w), suggesting a higher loss of SiO in the stream of flowing Ar from the mixtures. Furthermore, particle aggregation may be greater in mixed samples while carbon in carbon-coated samples prevent agglomeration and allow production of fine powders (e.g., 0.1-0.3 μm in diameter).

Ni²⁺ may be included in SiO₂/phenolic resin sols organizing primary colloidal particles (10 nm) into large secondary grains (1000 nm) of phenolic resin with embedded silica particles. Accordingly, the morphology of the resulting SiC may change from whisker-like (in the absence of Ni²⁺) to particulate.

Alternatively, SiC monoliths may be prepared by infiltration of pre-formed macro-/mesoporous (13 nm) SiO₂ monoliths with a THF solution of pre-condensed graphitic precursors (mesophased pitch). Drying and pyrolysis at 1400° C. may yield SiC—SiO₂ composites that, after removal of SiO₂ with ammonium hydrogen fluoride, affords SiC retaining the macro and mesoporous character of the starting silica artifact.

In general, it may be beneficial to mimic the structure of silica rather than that of carbon in the SMS of SiC. As described herein, a conformal coating of silica with an appropriate amount of the carbon precursor may be carried out cleanly in one reaction chamber together with the synthesis of a monolithic three-dimensional (3D) nanoparticulate silica framework. In effect, synthesis of porous SiC may be carried out quickly and reliably by reacting suitable precursors with minimum steps and byproducts. The methodology for the synthesis of 3D silica networks conformally coated with polymers may result in monolithic 3D core-shell nanostructures, referred to herein as crosslinked aerogels. Such crosslinked aerogels may provide advantageous mechanical properties despite having low density characteristics.

As described further below, a crosslinked aerogel may be a precursor for the synthesis of another porous material. for example, silicon carbide aerogels. Discussed below, a PAN may be used as a crosslinking polymer, which is used industrially for the pyrolytic manufacture of carbon fiber for automotive and aerospace applications.

### Examples: Materials

Anhydrous tetrahydrofuran (THF) was prepared by pre-drying HPLC-grade solvent over NaOH followed by distillation over LiAlH₄. Acrylonitrile (AN) obtained from Aldrich Chemical Co. was washed with a 5% (w/w) aqueous sodium hydroxide solution to remove the inhibitor, followed by distillation under reduced pressure. Methanol and toluene were obtained from Fisher. The free radical inititator. Si-AIBN, (4,4′-(diazene-1,2-diyl) bis-(4-cyano-N-(3-triethoxysilyl) propyl) pentanamide) was synthesized and kept in dry THF (0.112 M) at 4° C.

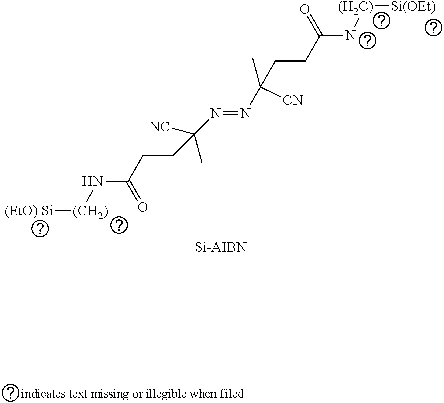

Preparation of polyacrylonitrile-(PAN-) crosslinked silica aerogels. The Si-AIBN stock solution was allowed to warm to room temperature, and an aliquot (23.0 mL, 0.0026 mol) was transferred into a round-bottom flask. The solvent was removed at room temperature under reduced pressure, and the resulting solid was dissolved in a mixture of methanol, tetramethoxysilane (TMOS) and AN. This is referred to as Solution A. A second solution (Solution B) was prepared by mixing methanol, AN, distilled water and 80 μL of 14.8 N NH₄OH. The total amounts of methanol, TMOS and AN were varied as shown in Table 1 (shown below) in order to: (a) keep constant the total mol amount of silicon (1 mol from TMOS+2 mol from Si-AIBN) in all samples, but vary the mol percent of silicon derived from Si-AIBN from 10 to 20 to 30% (corresponding samples are referred to as F-10, F-20 and F-30, respectively); and, (b) vary the volume percent of AN to methanol+AN from 30 to 45 to 60% v/v. Thus, three final samples were prepared for each Si-AIBN concentration. A predetermined amount of methanol and AN were divided equally between Solution A and Solution B. Solution B was added into Solution A and the mixture comprises the sol. The sol was shaken well and was poured into polypropylene molds (Wheaton polypropylene Omni-Vials, Part No. 225402, 1 cm in diameter). Sols gelled within 10-15 min. The resulting clear wet-gels were aged for 24 h at room temperature in their molds, exposed to UV light for 300 s (changing the angle of exposure frequently) using a UVitron International Intrelli-ray 600 shattered UV floodlight (600 W), heated at 55° C. for 12 h, solvent-exchanged with ethanol (3 times, 8 h per wash cycle-to remove gelation water), and finally solvent-exchanged again with toluene (3 times, 8 h per wash cycle-to remove free PAN from the pores). The resulting opaque-white gels were dried into PAN-crosslinked aerogels in an autoclave with liquid CO2 taken out at the end as a supercritical fluid (SCF). Alternatively, crosslinked wet-gels were also dried directly from the molds under ambient pressure for 2-3 days without any further washes. The ambient drying approach simplifies the process significantly, without any adverse effect on the quality of the final SiC monoliths. For comparison purposes, native samples (designated as F-10-00, F-20-00 and F-30-00) were also prepared by replacing AN with an equal volume of methanol (refer to Table 1).

TABLE 1
Formulations for one-pot synthesis of PAN-crosslinked silica aerogels

| | TMOS | Si-AIBN | CH₃OH | H₂O | AN |
|---|---|---|---|---|---|
| Formulation | mL (mol) | mL (mol) ^{a} | mL | mL | mL (mol) |
| F-10-00 | 3.465 (0.0234) | 11.5 (0.0130) | 9.00 | 1.5 | 0.00 (0.0000) |
| F-10-30 | 3.465 (0.0234) | 11.5 (0.0013) | 6.30 | 1.5 | 2.70 (0.0407) |
| F-10-45 | 3.465 (0.0234) | 11.5 (0.0013) | 4.95 | 1.5 | 4.05 (0.0611) |
| F-10-60 | 3.465 (0.0234) | 11.5 (0.0013) | 3.60 | 1.5 | 5.40 (0.0814) |
| F-20-00 | 3.068 (0.0207) | 23.0 (0.0026) | 9.00 | 1.5 | 0.00 (0.0000) |
| F-20-30 | 3.068 (0.0207) | 23.0 (0.0026) | 6.30 | 1.5 | 2.70 (0.0407) |
| F-20-45 | 3.068 (0.0207) | 23.0 (0.0026) | 4.95 | 1.5 | 4.05 (0.0611) |
| F-20-60 | 3.068 (0.0207) | 23.0 (0.0026) | 3.60 | 1.5 | 5.40 (0.0814) |
| F-30-00 | 2.68 (0.0181) | 34.5 (0.0039) | 9.00 | 1.5 | 0.00 (0.0000) |
| F-30-30 | 2.68 (0.0181) | 34.5 (0.0039) | 6.30 | 1.5 | 2.70 (0.0407) |
| F-30-45 | 2.68 (0.0181) | 34.5 (0.0039) | 4.95 | 1.5 | 4.05 (0.0611) |
| F-30-60 | 2.68 (0.0181) | 34.5 (0.0039) | 3.60 | 1.5 | 5.40 (0.0814) |

^{a} Volume of a stock solution of Si-AIBN (0.1122M) in THF.

Preparation of silicon carbide aerogels from PAN-crosslinked aerogels. PAN-crosslinked aerogels were initially aromatized by heating in air at 225° C. for 36 h. The color changed from white to brown. Subsequently, the PAN-crosslinked aerogels were transferred to an MTI GSL1600X-80 tube furnace (tube and lining both of alumina 99.8% pure, 45 mm and 51 mm inner and outer diameters of lining, 72 and 80 mm inner and outer diameters of the tube, 457 mm heating zone) and heated further under flowing Ar (70 mL min⁻¹). The temperature of the tube furnace was first raised within 2 h from ambient to 300° C. and it was maintained at that level for 3 h. Subsequently, the temperature was raised further within 2 h to 800° C., and maintained at that level for 3 h. Finally, the temperature was again raised within 5 h to the end carbothermal reaction temperature (from 1200° C. to 1600° C.) and it was maintained at that level for different time periods ranging from 36 h to 140 h. At the end of that period, the temperature was lowered to 600° C., flowing Ar was changed to flowing air, and excess of carbon was burned off by maintaining the temperature at that level for 5 h. Samples for analysis were removed at intermediate stages of the heating process (at 800° C. and at the end of the carbothermal process), by interrupting heating and by letting the tube furnace cool down to room temperature under flowing Ar.

### Examples: Methods and Analyses

Supercritical fluid CO₂ drying was conducted using an autoclave (SPI-DRY Jumbo Supercritical Point Drier, SPI Supplies, Inc., West Chester, PA). Bulk densities (ρP_{b}) were calculated from the weight and the physical dimensions of the samples. Skeletal densities (ρₛ) were determined using helium pycnometry with a Micromeritics AcuuPyc II 1340 instrument. Porosities were determined from the ρ_{b} and ρₛ values. Surface areas (σ) were measured by nitrogen adsorption/desorption porosimetry using a Micromeritics ASAP 2020 Surface Area and Pore Distribution analyzer. Samples for surface area and skeletal density determinations were outgassed for 24 h at 80° C. under vacuum before analysis. Average pore diameters were determined by the 4×V_{Total}/σ method, where V_{Total} is the total pore volume per gram of sample. V_{Total} was calculated either from the single highest volume of N₂ adsorbed along the adsorption isotherm, or from the relationship V_{Total}=(1/ρ_{b})−(1/ρₛ). The single point N₂ adsorption method tends to underestimate V_{Total} significantly when macropores are involved. The discrepancy between average pore diameters calculated by the two methods was taken as an indication of macroporosity. In that case, discussion of average pore diameters is based on values calculated using V_{Total}=(1/ρ_{b})−(1/ρₛ). Samples of cross-linked silica aerogels. silicon carbide and intermediates were characterized by solid ¹³C and ²⁹Si NMR spectroscopy using one-pulse sequence with magic angle spinning (at 7 kHz). Samples up to the point of aromatization (heated at 225° C.) were characterized by ¹³C CPMAS-TOSS pulse sequence solids NMR with broadband proton decoupling and magic angle spinning (at 5 kHz). Samples after carbonization (800° C.) contain no hydrogen and were characterized by one-pulse sequence and magic angle spinning (at 7 kHz). All samples were ground to fine powder and packed into 7 mm rotors. A Bruker Avance 300 wide bore NMR spectrometer equipped with a 7 mm CPMAS probe was used. The operating frequency for ¹³C and ²⁹Si was 75.483 and 59.624 MHz, respectively. ¹³C NMR spectra were referenced externally to glycine (carbonyl carbon at 176.03 ppm). ²⁹Si NMR spectra were referenced externally to neat tetramethylsilane (TMS, 0 ppm). Modulated differential scanning calorimetry (MDSC) was conducted in air with a TA Instrument Model 2920 apparatus at a heating rate of 10° C. min⁻¹. SiC samples at the end of processing were characterized by X-ray diffraction. Those experiments were performed with powders of the corresponding materials using a Scintag 2000 diffractometer with Cu Kα radiation and a proportional counter detector equipped with a flat graphite monochromator. Structural information for silicon carbide was obtained using the ICSD database version 2.01. The crystallite size was estimated with the Jade software (version 5.0, Materials Data, Inc.) using Scherrer's equation. A Gaussian correction for instrumental broadening was applied utilizing NIST SRM 660a LaB6 for the determination of the instrumental broadening. Scanning Electron Microscopy (SEM) was conducted with samples coated with Au—Pd using a Hitachi S-4700 field emission microscope.

Determination of organic matter in native samples. The incorporation of Si-AIBN in the silica (TMOS) framework was evaluated by correlating the amount of organic matter in native F-10-00, F-20-000 and F-30-00 aerogels with the concentration of Si-AIBN in their sol. The amount of organic matter was determined gravimetrically before and after heating native samples at 600° C. in air.

Determination of the PAN content in selective PAN—crosslinked samples. The same process as above was applied to F-20-45 samples. The weight percent of PAN thus was calculated by factoring in the ratio of SiO₂ and of the organic matter originating from Si-AIBN.

Determination of C:SiO₂ ratio available for the carbothermal reduction. This ratio was determined gravimetrically. by recovering samples at 800° C. during the carbothermal process. The samples were weighed and then heated again at 600° C. in air to burn off remaining carbon.

Determination of the conversion of SiO₂ to SiC. PAN-crosslinked samples with known content of silica were weighed before and after processing at different carbothermal temperatures followed by removal of residual carbon at 600° C. in air. The efficiency of the carbothermal reduction of SiO₂ was determined by correlating the initial amount of silica to the final weight of SiC.

### Results: Characteristics of Prepared Aerogels

For the specific examples provided, the flowchart shown below summarizes the overall process for the synthesis and conversion of PAN-coated silica aerogels to porous monolithic SiC. That process starts with the one-pot synthesis of PAN-coated silica wet-gels that are dried to PAN-crosslinked silica aerogels with SCF CO₂. The PAN coating is aromatized at 225° C. in air, and subsequently samples are placed in a tube furnace and are heated stepwise under flowing Ar to a range of terminal temperatures from 1200° C. to 1600° C. Unreacted carbon is removed at 600° C. in air. Although the entire process can be carried out continuously, several runs were interrupted at various intermediate stages and samples were analyzed in order to identify the controlling parameters and optimize the synthetic conditions for complete conversion of SiO₂ to monolithic SiC. Specifically, samples were also analyzed after aromatization at 225° C., after carbonization at 800° C., and before removal of unreacted carbon. Results are summarized in Tables 2-4. Alternatively, the entire process is shortened by eliminating the SCF CO₂ drying step; it was found (Table 5) that the porous SiC samples were virtually identical to those received by the lengthier process. The flowchart for the synthesis and characterization of SiC aerogels is provided as follows:

Synthesis of PAN-crosslinked aerogels. Mesoporous monolithic silica was coated (crosslinked) with PAN in one pot through surface initiated free-radical polymerization (SIP) of the monomer (AN) according to equation (3), as follows:

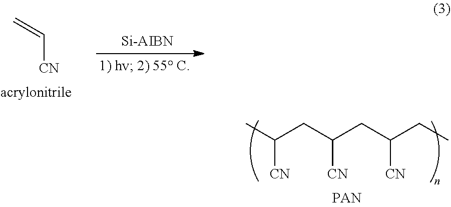

Si-AIBN, a bidentate free-radical initiator, was designed specifically to attach itself on silica at both ends so that the polymer produced by thermal or photochemical cleavage of the central —N═N—group of the initiator remains surface-bound, rendering post-crosslinking washes unnecessary. Nevertheless, it was found that some free PAN is still produced in the pores. presumably by an unidentified radical-transfer mechanism, and, although its removal is not necessary. post-crosslinking washes were conducted anyway to confirm and understand the topology of the processes taking place at the surface of silica during its conversion to SiC. It is further noted that up to now crosslinking reagents for this class of materials have been introduced by time-consuming solvent exchanges after gelation; here, however, since gelation of TMOS (a nucleophilic substitution process) does not interfere with the free-radical crosslinking reagents. both gelation and crosslinking chemistries have been included together in the sol, rendering post-gelation (pre-crosslinking) solvent exchanges unnecessary. Gelation takes place at room temperature, while crosslinking is triggered post-gelation during aging in one pot (see flow chart above).

The amount of AN in the sol is related to the amount of carbon produced on the surface of silica during the carbonization process (see below). On the other hand, since surface-confined PAN is expected to be capped by two initiator fragments, the mol ratio of Si-AIBN:AN in the sol controls the length of the interparticle PAN tethers. By varying the Si-AIBN:total Si (TMOS+Si-AIBN) mol ratio (the total mol of Si remaining constant) from 0.1 to 0.2 to 0.3, it was found gravimetrically that the amount of Si-AIBN-related organic matter in the native (non-crosslinked) samples varied linearly (R=0.99) from 15.9% w/w to 21.8% w/w to 26.2% w/w. respectively, signifying that all Si-AIBN was incorporated in the silica structure. The complete characterization data for the native and PAN-crosslinked samples are summarized in Table 2.

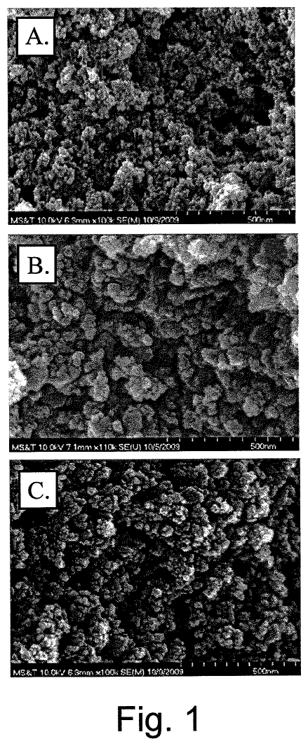

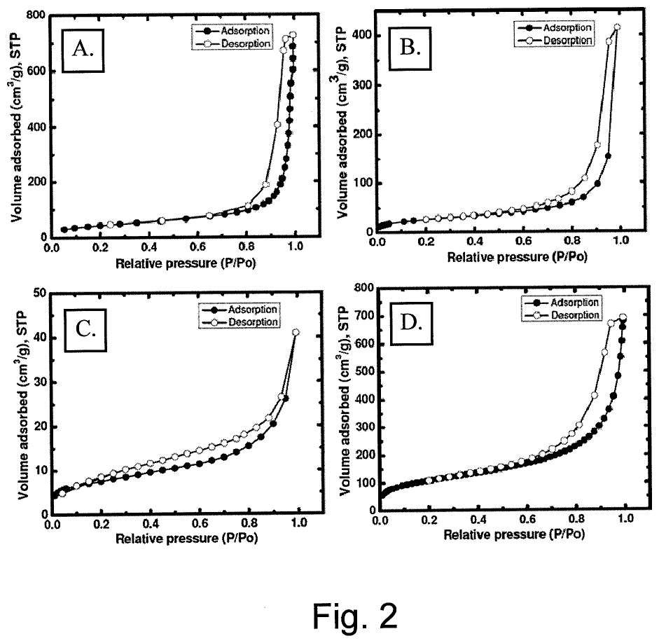

PAN-crosslinking under our conditions causes a density increase relative to the native samples by a factor of up to 2.5 (typical for these types of materials). Generally, crosslinked samples shrink less relative to molds in comparison with native samples. Microscopically. crosslinked samples, shown in section A of FIG. 1, are observed to be similar to their native counterparts, consistent with a tight conformal polymer coating of the skeletal silica nanoparticles. N₂ adsorption isotherms are Type IV, showing the characteristic desorption hysteresis of mesoporous materials, shown in Section A of FIG. 2. The BET surface area, σ, has been decreased relative to the area of the native samples, as listed in Table 2 provided below, indicating that the polymer has smoothed out the surface of the secondary particles blocking access for N₂ to the smaller crevices on the skeletal framework, and is consistent with the average pore diameter increase reported in Table 2. It is noted that average pore diameters calculated either from the single point total pore volume (V_{Total}) obtained from the adsorption isotherm, or via the V_{Total}=1/ρ_{b}−1ρₛ method are close numerically and both within the mesoporous range (2-50 nm), further supporting the mesoporous nature of those samples. The porosity, Π, as % v/v of empty space, has been decreased from ˜90% in the native samples to ˜70% in the crosslinked samples, consistent with the particle size increase (calculated via radius r=3/ρₛσ, Table 2) brought about by the conformal polymer coating.

TABLE 2
Selected properties of PAN-crosslinked silica aerogels

| | | | | skeletal | porosity, | BET surface | average | | particle |
|---|---|---|---|---|---|---|---|---|---|
| | diameter | percent | bulk density, | density, | II (% void | area, σ | pore | | radius, |
| sample | (cm) ^{a} | shrinkage ^{b} | ρ_{b} (g cm⁻³) | ρₛ (g cm⁻³) ^{c} | space) | (m² g⁻¹) | diameter (nm) ^{d} | | r (nm) ^{e} |
| F-10-00 | 0.925 ± 0.003 | 5.0 | 0.177 ± 0.004 | 1.887 ± 0.006 | 90 | 681 | 8.5 | [10.0] | 2.2 |
| F-10-30 | 0.923 ± 0.001 | 7.7 | 0.329 ± 0.011 | 1.498 ± 0.003 | 78 | 322 | 14.1 | [14.5] | 6.2 |
| F-10-45 | 0.938 ± 0.003 | 6.2 | 0.426 ± 0.004 | 1.462 ± 0.003 | 71 | 206 | 13.2 | [20.1] | 10.0 |
| F-10-60 | 0.945 ± 0.007 | 5.5 | 0.475 ± 0.007 | 1.478 ± 0.002 | 68 | 228 | 15.6 | [17.6] | 8.9 |
| F-20-00 | 0.920 ± 0.005 | 8.0 | 0.190 ± 0.002 | 1.798 ± 0.004 | 89 | 647 | 14.28 | [9.9] | 2.2 |
| F-20-30 | 0.936 ± 0.004 | 6.4 | 0.360 ± 0.005 | 1.435 ± 0.009 | 75 | 275 | 15.0 | [15.6] | 7.6 |
| F-20-45 | 0.948 ± 0.003 | 5.2 | 0.414 ± 0.004 | 1.45₈ ± 0.01₀ | 72 | 157 | 23.7 | [26.7] | 13.1 |
| F-20-60 | 0.947 ± 0.004 | 5.3 | 0.467 ± 0.004 | 1.423 ± 0.007 | 67 | 144 | 13.9 | [26.6] | 14.6 |
| F-30-00 | 0.922 ± 0.003 | 7.8 | 0.198 ± 0.003 | 1.705 ± 0.002 | 88 | 643 | 9.5 | [9.4] | 2.7 |
| F-30-30 | 0.925 ± 0.002 | 7.5 | 0.378 ± 0.003 | 1.428 ± 0.009 | 74 | 195 | 14.3 | [21.5] | 10.8 |
| F-30-45 | 0.931 ± 0.002 | 6.9 | 0.470 ± 0.002 | 1.448 ± 0.007 | 68 | 147 | 15.6 | [26.6] | 14.1 |
| F-30-60 | 0.950 ± 0.001 | 5.0 | 0.473 ± 0.003 | 1.42₃ ± 0.08₉ | 67 | 151 | 32.4 | [25.1] | 13.9 |

^{a} Average of 5 samples.
^{b} Relative to the molds (1 cm diameter).
^{c} One sample, average of 50 measurements.
^{d} By the 4 × V_{Total}/σ method. For the first number, V_{Total} was calculated by the single-point adsorption method; for the number in brackets V_{Total} was calculated via V_{Total} = (1/ρ_{b}) − (1/ρₛ).
^{e} Calculated via r = 3/ρₛσ.

Aromatization of PAN-crosslinked aerogels. Conversion of PAN to carbon involves prior aromatization, which may be induced oxidatively by heating the polymer between 270 and 300° C. in air, demonstrated in equation (4), as follows:

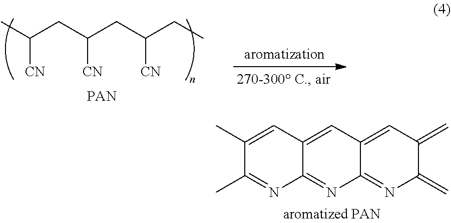

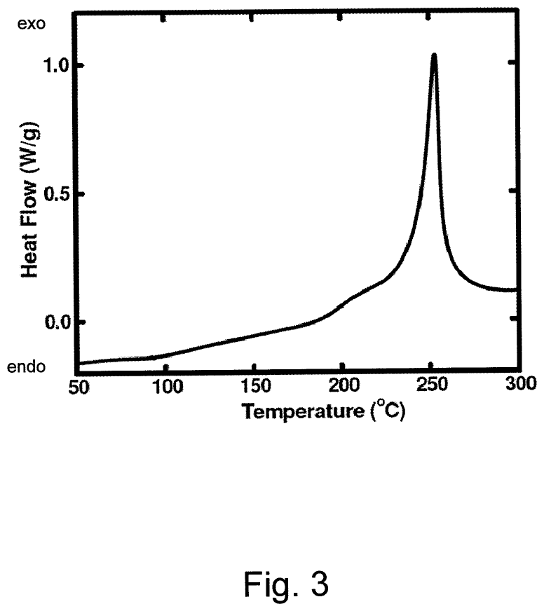

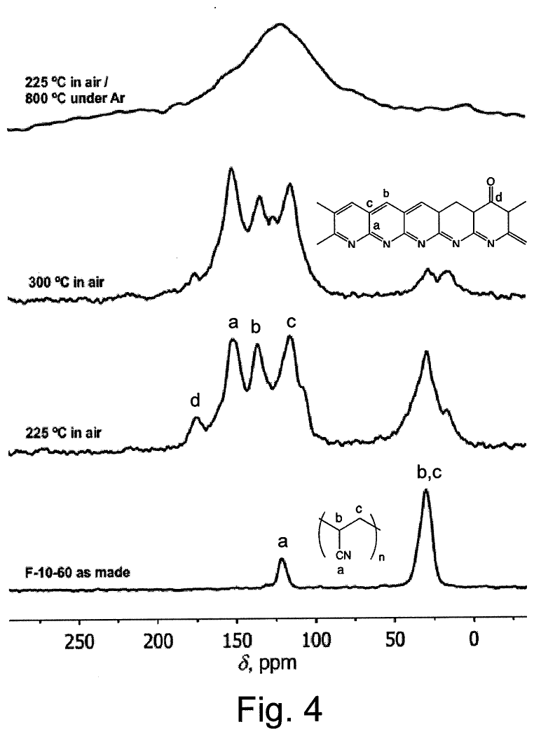

Indeed, direct heating of PAN-crosslinked aerogels at 800° C. in argon causes decomposition of the polymer and complete loss of the organic matter. Heating PAN-crosslinked samples in air shows a sharp exotherm with a peak at 253° C. (by DSC shown in FIG. 3). Aromatization (followed by ¹³C NMR shown in FIG. 4) takes place at both sides of the exotherm, albeit more slowly at the low temperature end (225° C. versus 300° C., referring to FIG. 4). However, processing PAN-crosslinked silica aerogel monoliths at 300° C. tends to break them into small pieces, presumably due to stresses on the silica framework created by the structural rearrangement of the polymer during its aromatization. On the other hand, a combination of conditions expected to produce shorter polymer chains (higher Si-AIBN concentrations: F-20 and F-30 formulations) with lower aromatization temperatures seem to yield monoliths with a 100% success rate. Microscopically, those samples look quite similar to their parent PAN-crosslinked aerogels, as shown in Section B of FIG. 1. Therefore, for further processing, samples were heated for longer time periods (36 h) at 225° C. as depicted in the flow chart above. The incomplete aromatization of PAN under those conditions (see spectrum in FIG. 4 labeled “225° C. in air”) necessitated determination of the C:SiO₂ mol ratio produced after carbonization as a function of the initial formulation of the PAN-crosslinked samples.

Carbonization of aromatized PAN-crosslinked aerogels. Aromatized PAN-crosslinked aerogels are converted to SiC by heating in the 1200-1600° C. range under Ar. As confirmed by ¹³C NMR shown in FIG. 4, at around 800° C. aromatized PAN is converted to carbon, in accordance with equation (5), which is as follows:

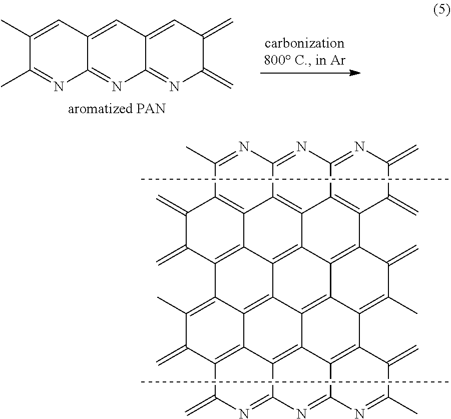

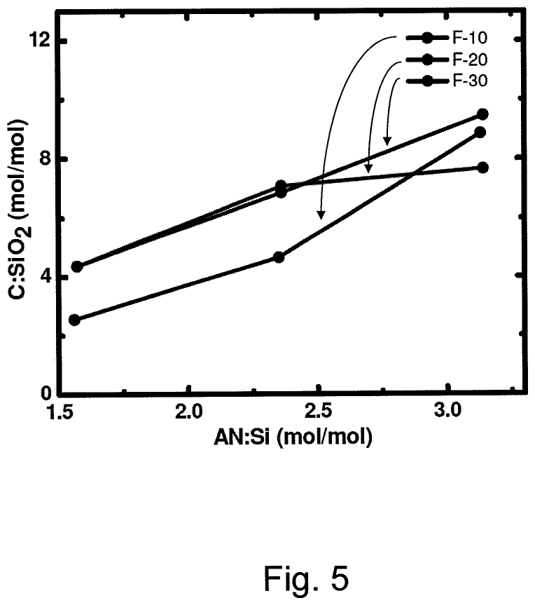

Aromatized samples heated at just 800° C. allow correlation of the initial synthetic conditions to the C:SiO₂ mol ratio. The complete analysis of the carbonized samples is summarized in Table 3, provided below. Carbonization causes additional shrinkage (12-13%) relative to the parent PAN-crosslinked aerogel precursors, but samples retain their shape and micro-morphology (see SEM image in Section C of FIG. 1). N₂ adsorption isotherms shown in Section B of FIG. 2 show signs of macroporosity (lower total volume of N₂ adsorbed, lack of saturation, most of the increase in the volume adsorbed is observed above 90% of relative pressure), and pore diameters calculated via the V_{Total}/σ method using V_{Total} obtained by the single point versus the V_{Total}=1/ρP_{b}/σₛ method do not match, the latter being significantly larger, in fact in the range of macropores (>50 nm, see Table 3 below). The BET surface area after carbonization is also significantly lower than that of the parent PAN-crosslinked samples (69-124 m²g⁻¹ versus 140-320 m²g⁻¹, respectively; compared from Tables 2 and 3). Consequently, the particle size of the carbonized samples is calculated larger than that of the parent PAN-crosslinked aerogels (11.0-20.3 nm versus 6.2-14.6 nm. respectively). The porosimetry data considered together with SEM are consistent with a rather compact C-coating blocking access to the underlying silica network. The C: SiO₂ ratio (indicated in Table 3) was determined gravimetrically and increases together with the AN:SiO₂ mol ratio in the original sol (see FIG. 5) from substoichiometric (e.g., 2.55 for the F-10-30 formulation) to a little over the stoichiometric (˜4.4 for the F-10-45, F-20-30 and F-30-30 formulations) to over twice the stoichiometric ratio of equation (1) (samples F-10-60, F-20-45, F-10-50, F-30-45 and F-30-60). Since F-10 samples tend to break in pieces after aromatization, and because F-30 samples use a larger amount of Si-AIBN unnecessarily, only F-20-30 and F-20-45 samples were considered for further processing.

TABLE 3
Characterization of PAN-crosslinked silica aerogels after pyrolysis at 800° C.

| | | | | skeletal | porosity, | BET surface | average | particle | |
|---|---|---|---|---|---|---|---|---|---|
| | diameter | percent | bulk density, | density, | II (% void | area, σ | pore | radius, | C:SiO₂ |
| sample | (cm) ^{a} | shrinkage ^{a, b} | ρ_{b} (g cm⁻³) ^{a} | ρₛ (g cm⁻³) ^{c} | space) | (m² g⁻¹) | diameter (nm) ^{d} | r (nm) ^{e} | (mol/mol) |
| F-10-30 | 0.823 | 13 | 0.290 | 2.18₇ ± 0.02₄ | 86 | 124 | 24.2 [60.8] | 11.0 | 2.55 |
| F-10-45 | 0.832 | 12 | 0.333 | 2.118 ± 0.003 | 84 | 93 | 13.8 [76.1] | 15.1 | 4.65 |
| F-10-60 | 0.845 | 11 | 0.357 | 2.149 ± 0.006 | 83 | 79 | 16.5 [90.5] | 17.6 | 8.85 |
| F-20-30 | 0.849 | 13 | 0.276 | 2.13₄ ± 0.04₂ | 87 | 96 | 13.5 [76.9] | 14.5 | 4.36 |
| F-20-45 | 0.834 | 12 | 0.365 | 2.17₈ ± 0.01₁ | 83 | 94 | 12.8 [76.7] | 14.6 | 7.08 |
| F-20-60 | 0.834 | 12 | 0.410 | 2.140 ± 0.008 | 80 | 74 | 18.0 [93.2] | 18.9 | 7.66 |
| F-30-30 | 0.843 | 13 | 0.321 | 2.17₈ ± 0.01₁ | 85 | 99 | 17.1 [74.9] | 13.9 | 4.36 |
| F-30-45 | 0.822 | 13 | 0.396 | 2.156 ± 0.009 | 81 | 79 | 14.2 [88.1] | 17.4 | 6.85 |
| F-30-60 | 0.840 | 12 | 0.495 | 2.140 ± 0.007 | 77 | 69 | 18.4 [90.0] | 20.3 | 9.49 |

^{a} Single sample.
^{b} Relative to the PAN-crosslinked aerogels.
^{c} Single sample, average of 50 measurements.
^{d} By the 4 × V_{Total}/σ method. For the first number, V_{Total} was calculated by the single-point adsorption method; for the number in brackets V_{Total} was calculated via V_{Total} = (1/ρ_{b}) − (1/ρₛ).
^{e} Calculated via r = 3/ρₛσ.

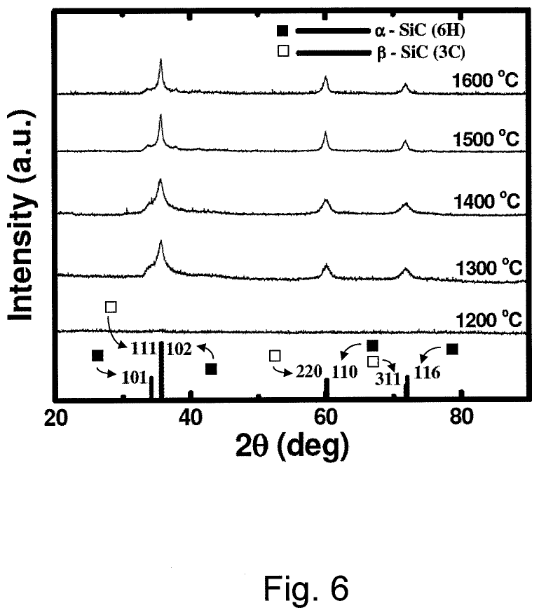

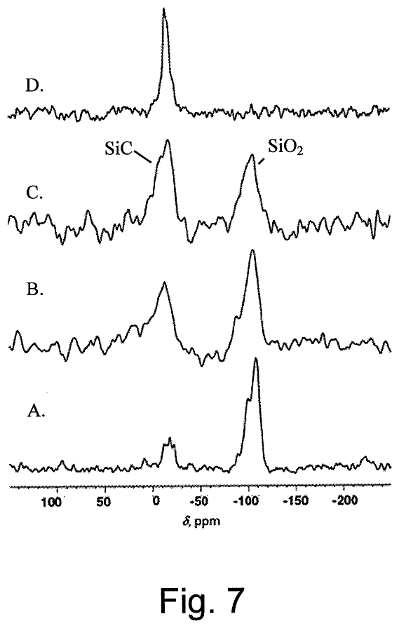

Conversion of aromatized PAN-crosslinked aerogels to SiC. Thermodynamically, equation (1) and associated elementary processes described further below depend on the partial pressure of CO. Thus, while under atmospheric pressure, generation of SiC requires temperatures above ˜1754° C., thermobarometric analysis under dynamic vacuum (10⁻² Pa) has shown that carbothermal reduction of silica cross-linked aerogels impregnated with saccharose can start at 1100° C. Similarly, under dynamic Ar-flow (1 kPa of total SiO and CO pressure), SiC started forming from 1220° C. Ar was flowed for the carbothermal reduction and materials were prepared in the 1200-1600° C. range. Materials characterization data for selected samples cleaned of unreacted carbon, namely F-20-30 and F-20-45, processed at different temperatures for different times are summarized in Table 4. ²⁹Si NMR was used for differentiating silicon from SiC (−13 ppm) and SiO₂ (−105 ppm), even in amorphous phases. Indeed, although according to XRD data shown in FIG. 6, cubic (3C of β-) SiC starts showing up above 1300° C., and ²⁹Si NMR shown in FIG. 7 shows a 3.8:1 mol/mol ratio of SiC:SiO₂ at 1200° C. After pyrolysis at 1300° C., the relative amount of SiC increases (the SiC:SiO₂ mol ratio reaches 6.6). and after pyrolysis at 1600° C., polycrystalline SiC (mostly 3C with a small amount of 6H) is the only detectable Si-phase. Using literature density values for silicon carbide (3.20 g cm⁻³) and sintered amorphous silica (2.1 g cm⁻³). SiC: SiO₂ mol ratios determined by ²⁹Si NMR can be converted to the skeletal densities expected of the final C-cleaned samples. Thus, it is calculated from the data of Sections B and C in FIG. 7 that the expected skeletal densities (Ps) of terminal free-of-carbon F-20-30 samples should be 2.969 g cm⁻³ and 3.054 g cm⁻³ for samples pyrolyzed at 1200° C. and 1300° C., respectively. Those values agree well with the experimental p, data (2.968 g cm⁻³ and 3.014 g cm⁻³, respectively, referring to Table 4), suggesting and validating use of Ps data for assessing purity of the SiC. Indeed, F-20-45 samples processed at 1600° C. show only the ²⁹Si resonance peak of SiC shown in Section D of FIG. 7 and their skeletal density is that of pure SiC, as indicated in Table 4.

TABLE 4
Characterization of SiC aerogels prepared under different conditions

| | | | | | | | | | |
|---|---|---|---|---|---|---|---|---|---|
| | | | | skeletal | porosity, | BET surface | average | particle | Crystallite |
| sample ° C. | diameter | shrinkage | bulk density, | density, | II (% void | area, σ | pore | radius, | size |
| (hours) | (cm) ^{a} | (%) ^{a, b} | ρ_{b} (g cm⁻³) ^{a} | ρₛ (g cm⁻³) ^{c} | space) | (m² g⁻¹) | diameter (nm) ^{d} | r (nm) ^{e} | (nm) ^{f} |

F-20-30 (C:SiO₂ = 4.36 mol/mol)

| | | | | | | | | | | |
|---|---|---|---|---|---|---|---|---|---|---|
| 1200(36) | 0.487 | 48 | 0.623 | 2.96₈ ± 0.02₄ | 81 | 221 | 14.6 | [23.0] | 4.6 | ^{g} |
| 1200(72) | 0.555 | 41 | 0.533 | 2.94₄ ± 0.01₇ | 78 | 198 | 15.6 | [31.0] | 5.1 | ^{g} |
| 1300(36) | 0.536 | 43 | 0.591 | 3.01₄ ± 0.02₈ | 79 | 108 | 20.9 | [51.4] | 9.4 | |
| | 7.5 ± 0.9 | | | | | | | | | |
| 1300(72) | 0.540 | 42 | 0.526 | 3.07₈ ± 0.01₀ | 76 | 42 | 21.3 | [150] | 23.2 | ^{h} |
| 1400(36) | 0.578 | 39 | 0.503 | 3.02₁ ± 0.01₉ | 75 | 16 | 21.2 | [415] | 61.9 | 14.6 ± 0.3 |
| 1400(72) | 0.565 | 40 | 0.515 | 3.11₈ ± 0.01₃ | 74 | 18 | 15.4 | [360] | 53.5 | ^{h} |

F-20-45 (C:SiO₂ = 7.08 mol/mol)

| | | | | | | | | | | |
|---|---|---|---|---|---|---|---|---|---|---|
| 1200(36) | 0.578 | 30 | 0.410 | 2.919 ± 0.006 | 71 | 394 | 17.6 | [21.3] | 2.6 | ^{g} |
| 1200(72) | 0.567 | 40 | 0.401 | 2.92₈ ± 0.03₂ | 71 | 381 | 16.1 | [22.6] | 2.7 | ^{g} |
| 1200(110) | 0.563 | 40 | 0.447 | 2.91₇ ± 0.09₉ | 71 | 370 | 10.8 | [20.5] | 2.8 | ^{g} |
| 1200(140) | 0.583 | 38 | 0.441 | 2.9₃ ± 0.1₂ | 69 | 385 | 9.4 | [20.0] | 2.7 | ^{g} |
| 1300(36) | 0.589 | 38 | 0.473 | 3.08₈ ± 0.01₄ | 71 | 53 | 22.7 | [135] | 18.3 | ^{h} |
| 1300(72) | 0.612 | 35 | 0.446 | 3.17₀ ± 0.02₈ | 72 | 22 | 18.1 | [350] | 43.0 | 7.1 ± 0.8 |
| 1400(72) | 0.598 | 37 | 0.481 | 3.15₃ ± 0.05₄ | 72 | 20 | 12.5 | [353] | 47.6 | 14.9 ± 0.9 |
| 1500(72) | 0.590 | 38 | 0.430 | 3.19₀ ± 0.03₃ | 70 | 16 | 16.9 | [502] | 58.8 | 16.6 ± 0.8 |
| 1600(72) | 0.579 | 39 | 0.482 | 3.20₀ ± 0.04₃ | 75 | 13 | 21.7 | [542] | 72.1 | 16.5 ± 1.3 |

^{a} Analysis of a single sample for each formulation.
^{b} Shrinkage relative to the diameter of the PAN-crosslinked aerogels.
^{c} Analysis of a single sample, average of 50 measurements.
^{d} By the 4 × V_{Total}/σ method. For the first number, V_{Total} was calculated by the single-point adsorption method; for the number in brackets V_{Total} was calculated via V_{Total} = (1/ρ_{b}) − (1/ρₛ).
^{e} Calculated via r = 3/ρₛσ.
^{f} By XRD using the Scherrer equation; averages from the values obtained from the (111), (220) and (311) reflections.
^{g} Amorphous.
^{h} Not determined.

Overall, Table 4 shows that pyrolytically F-20-30 and F-20-45 samples behave similarly. For example, above 1400° C., there is no significant difference either in their degree of shrinkage or their bulk densities; below 1400° C. all samples processed for shorter time periods (36 h rather than 72 h) seem to contain more unreacted silica, as reflected by consistently lower ρₛ values. There are some subtle differences, however. At lower temperatures (1200 and 1300° C.), F-20-30 samples shrink more (43-48%) than their more carbon-rich F-20-45 counterparts (30-40%), and that difference is reflected directly into higher bulk densities (˜0.60 g cm⁻³ versus ˜0.45 g cm⁻³, respectively). To explain these shrinkage and density differences, it is suggested that although all carbothermal reduction temperatures used are well above the typical sintering temperatures of sol-gel silica (˜1050° C.), nevertheless the thicker C-coating of the F-20-45 samples prevents that process more effectively. F-20-30 samples have a tendency to shrink more and contain slightly more unreacted silica, and C-rich F-20-45 samples are converted to pure SiC with relative ease (their ρₛ values become within error equal to that of pure SiC even at 1300° C. for 72 h of processing).

As established gravimetrically, PAN-crosslinked F-20-45 samples consist of 32% w/w SiO₂, 8.9% w/w Si-AIBN related organic matter and 59% w/w PAN. In turn, according to the data of Table 5, the SiO₂-to-SiC conversion efficiency for samples processed between 1300° C. and 1600°° C. can be considered, within error, as 100% complete.

TABLE 5
Conversion efficiency of SiO₂ in PAN-crosslinked F-20-45 samples into SiC

| | | | | | calculated | |
|---|---|---|---|---|---|---|
| processing | sample | weight of | expected | “crude” ^{c} | weight of | SiC yield |
| at ° C. ^{a} | (g) | SiO₂ (g) ^{b} | SiC (g) | material (g) | pure SiC (g) ^{d} | (% w/w) |
| 1300/600 | 1.1987 | 0.3836 | 0.2578 | 0.2581 | 0.2544 | 98.7 |
| 1400/600 | 1.1677 | 0.3737 | 0.2511 | 0.2570 | 0.2358 | 93.9 |
| 1500/600 | 1.1498 | 0.3679 | 0.2473 | 0.2511 | 0.2500 | 101.1 |
| 1600/600 | 1.1504 | 0.3681 | 0.2474 | 0.2384 | 0.2384 | 96.4 |

^{a} Processing time at the two temperatures: 72 h/5 h, as described in the Experimental Section.
^{b} Based on 32% w/w silica.
^{c} “Crude” means uncorrected for the amount of SiO₂ contained.
^{d} Calculated by considering the SiC/SiO₂ mol/mol ratio in the samples as dictated by the skeletal density data (Table 4).

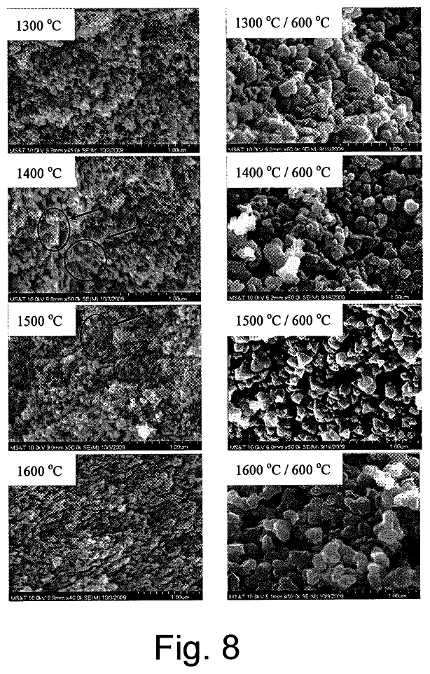

Spatial information for the location of the carbothermal reduction is obtained by SEM before and after oxidative removal of unreacted carbon. Before treatment at 600° C. in air, F-20-45 samples heated anywhere between 1300° C. and 1600° C. look superficially similar to their carbonized precursors recovered at 800° C., comparing the left column of FIG. 8 to Section C of FIG. 1. Upon closer examination of FIG. 8, larger particles (pointed at by circles and arrows) are discernible under the top layer. After treatment at 600° C. in air the debris is removed, confirming that it consists of unreacted carbon. All samples having been heated carbothermally for 72 h between 1300° C. and 1600° C. look identical to one another (right column of FIG. 8). No whisker-like material is seen in the pores. All samples are macroporous (confirmed by N₂ adsorption—see Section C of FIG. 2) with average pore diameters between 135 and 540 nm (Table 4). By XRD, shown in FIG. 6, SiC particles are polycrystalline and the crystallite size (via the Scherrer equation) increases with the processing temperature from 7.1 nm in samples prepared at 1300° C. to 16.5 nm for samples processes at 1600° C. It is noted that those values should be considered as lower limits because the (111), (220) and (311) reflections of —SiC coincide with the (102), (110) and (116) reflections of α-SiC, causing additional broadening. BET surface areas are relatively low (in the 13 to 22 m² g⁻¹ range), reflecting the macroporosity and suggesting that the crystallites within the larger particles observed by SEM (80-150 nm in diameter) are closely packed with no gaps or crevices.

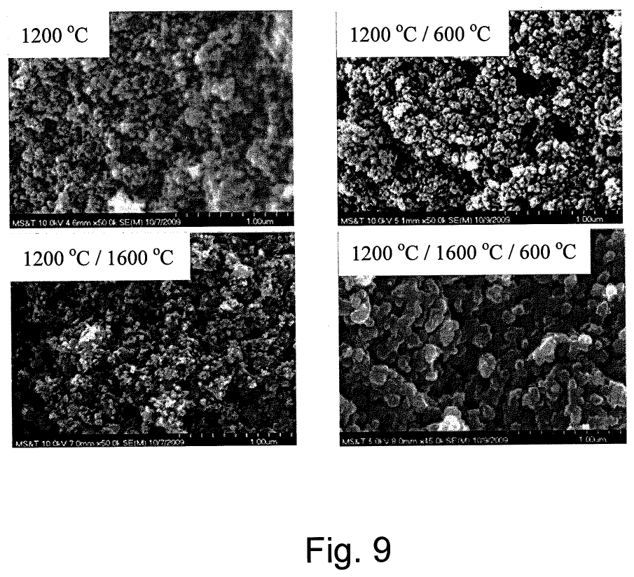

Although F-20-45 samples processed just at 1200° C. under Ar do not look very different than the others, as shown in FIG. 9, upon oxidative removal of the residual carbon, they do have a completely different microstructure from samples processed at higher temperatures (FIG. 8): they are mesoporous (Av. Pore Diam. ˜20 nm), they have large surface areas (˜380 m² g⁻¹), and consist of smaller particles (˜5 nm in diameter). They are also amorphous by XRD. Yet, by considering their skeletal density (˜2.92 g cm⁻³), they would consist 75% mol/mol of SiC and 25% mol/mol of SiO₂. Also, as shown in FIG. 9. reintroducing those samples into the tube furnace and heating further at 1600° C. followed by oxidative cleaning generates the same structures observed by direct heating at 1600/600° C. referring to FIG. 8. Therefore, although processing at 1200° C. is sufficient to produce SiC, it seems that grain growth occurs between 1300 and 1600° C.

TABLE 6
Characterization of SiC aerogels processed from PAN-crosslinked aerogels without SCF CO₂ drying. ^{a}

| | | | | | | | | | |
|---|---|---|---|---|---|---|---|---|---|
| | | | bulk | skeletal | porosity, | BET surface | average | particle | crystallite |
| sample ° | diameter | shrinkage | density, | density, | II (% void | area, σ | pore | radius, ^{d} | size ^{e} |
| C. (h) | (cm) | (%) ^{b} | ρ_{b} (g cm⁻³) | ρₛ (g cm⁻³) | space) | (m² g⁻¹) | diameter (nm) ^{c} | r (nm) | (nm) |

F-20-45 (C:SiO₂ = 7.08 mol:mol)

| | | | | | | | | | |
|---|---|---|---|---|---|---|---|---|---|
| 1500 (72) | 0.550 | 42 | 0.587 | 3.17₈ ± 0.01₈ | 82 | 18 | 19.7 [308] | 52.4 | 14.8 ± 1.2 |

^{a} Data for a sample processed carbothermally at the temperature and time-period indicated, followed by oxidative removal of unreacted carbon at 600° C. in air for 5 h.
^{b} Shrinkage relative to the diameter of the PAN-crosslinked aerogels.
^{c} By the 4 × V_{Total}/σ method. For the first number, V_{Total} was calculated by the single-point adsorption method; for the number in brackets V_{Total} was calculated via V_{Total} = (1/ρ_{b}) − (1/ρₛ).
^{d} Calculated via r = 3/ρₛσ.
^{e} By XRD using the Scherrer equation; averages from the values obtained from the (111), (220) and (311) reflections.

Table 6 summarizes the properties of a F-20-45 sample processed directly through aromatization, carbonization, carbothermal reduction and oxidative cleaning of unreacted carbon without prior removal of loose PAN or SCF CO₂ drying. A comparison of the data in Table 6 with corresponding data in Table 4 shows that the materials properties of both kinds of porous SiC are substantially the same, within a slight error. This approach provides economic advantages and significant leverage from a practical applications perspective.

Further Discussion: Schematics of Reaction Mechanisms

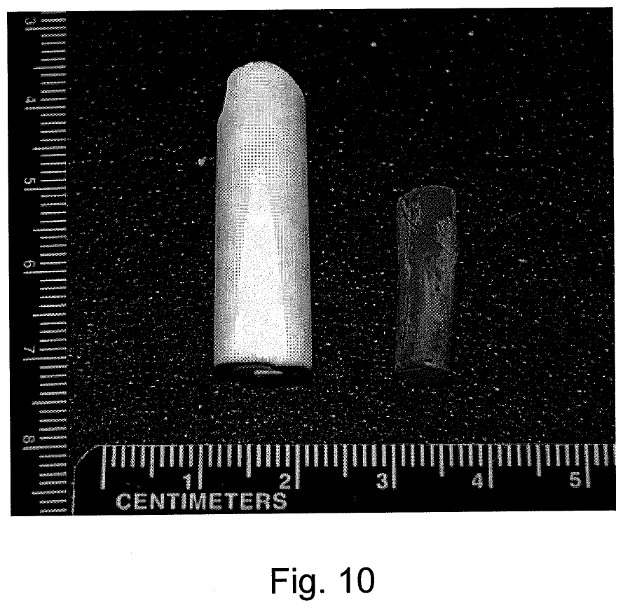

SiC aerogels prepared by processes described herein may shrink to about 60% of the size of the original molds, yet may remain generally crack-free and monolithic. FIG. 10 shows a photograph taken of a PAN-crosslinked silica aerogel monolith as compared with a resulting SicC aerogel monolith prepared using processing steps described above (i.e., aromatization, carbothermal reduction and oxidative removal of unreacted carbon).

After a step of cleaning of the unreacted carbon, samples pyrolyzed above 1300° C. may look similar to one another at a microscopic level, yet distinctly different from those pyrolyzed at 1200° C. The carbothermal reduction of equation (1) may start as a solid-solid or possibly as a liquid-solid reaction between SiO₂ and C. In some cases, although quartz melts at about 1650° C., nanoparticulate silica in base-catalyzed silica aerogels may sinter completely at 1050° C., resulting from the surface melting at lower temperatures. Hence, the reaction between SiO₂ and C, at least initially. may depend on the contact area between the two reactants; from that perspective, the starting material of this study has been designed specifically to turn the entire mesoporous surface of silica, or a portion of the mesoporous surface, into a contact area with C. Accordingly, the initial elementary process between SiO₂ and C may follow equation (6):

$${SiO}_{2} ( s or 1 ) + C ( s ) SiO ( g ) + CO ( g ) \qquad ( 6 )$$

Once SiO(g) is formed, synthesis of SiC may follow via a gas-solid reaction with carbon:

$$SiO ( g ) + 2 C ( s ) SiC ( s ) + CO ( g ) \qquad ( 7 )$$

CO(g) from equations (6) and (7), reacts with silica via equation (8), producing more SiO (g), while

$${SiO}_{2} ( s ) + CO ( g ) SiO ( g ) + {CO}_{2} ( g ) \qquad ( 8 )$$

CO₂ comproportionates with C according to the following reaction:

$${CO}_{2} ( g ) + C ( s ) 2 CO ( g ) \qquad ( 9 )$$

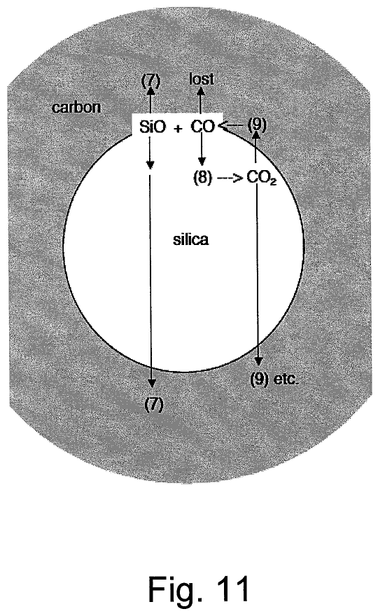

FIG. 11 illustrates a schematic example of carbothermal processes at the interface of silica and carbon. In some cases, there is an absence of reactions between SiO and CO in the pores via equation (2) to yield whiskers. FIG. 1 illustrates an embodiment of a topological summary of a sequence of reactions above leading to SiC. According to this model, about half of the CO escapes unreacted through the carbon coating. Therefore, since subsequent gasification of SiO₂ into SiO may involve reaction with CO according to equation (8), for complete reaction of SiO₂, the C:SiO₂ ratio may be double of that required stoichiometrically via equation (1), i.e., at least 6. Based on ρₛ values listed in Table 4, the SiC content in the F-20-30 samples (C:SiO)₂=4.4) reacted for 72 h at 1200-1600° C. is 76-93 mol percent, which is of course higher than what is expected from the model (75%), but lower than the SiC content in F-20-45 samples (C:SiO₂=7.1) where it reaches 100%. Thus, diffusion of CO through the C layer should be restricted but not completely prevented. Accordingly, a C:SiO₂ ratio higher than the stoichiometric ratio of 3, referring to equation (1) is required for complete conversion of SiO₂ to SiC.

Upon closer examination, since equation (6), which sets off the process, takes place at the points of contact between SiO₂ and C. once those points have been consumed, equation (6) and all subsequent processes should stop. However, as data from the F-20-45 samples show formation of SiC can continue till complete conversion SiO₂ to SiC. Continuation of the carbothermal process could be attributed to the solid-solid reaction of equation (10) at the points of contact of SiC with SiO₂, as follows:

$$SiC ( s ) + 2 {SiO}_{2} ( s ) 3 SiO ( g ) + CO ( g ) \qquad ( 10 )$$

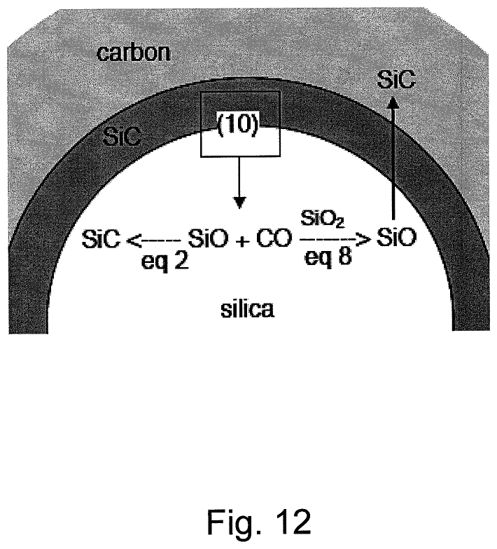

Equation (10) re-generates SiO(g) and it is known that it causes loss of SiC during prolonged contact with SiO₂ at high temperatures. Referring to FIG. 12 which illustrates a schematic of processes at the interface of silica and newly formed silicon carbide. equation (10) injects 3 mols of SiO and 1 mol of CO in the yet unreached SiO₂ layer. One mol of SiO may react with 3 mols of CO, referring to equation (2). yielding SiC nanocrystals, while the remaining SiO has no other option but to diffuse through SiC and react with C as it emerges into the outer C layer yielding SiC according to equation (7). Alternatively, CO injected into the SiO₂ layer may react with SiO₂ according to equation (8) producing more SiO. Diffusion of SiO through SiC may be slow, explaining generally long reaction times. Overall. the initial SiC layer is consumed internally and grows externally in a process somewhat reminiscent of an inside out growth mechanism of certain inorganic fullerene-like layers structures. Larger crystallites at high temperatures are attributed to faster kinetics for equation (2). Rather uniform SiC particle sizes between 1300° C. and 1600° C. can be explained if silica nanoparticles melt between 1200 and 1300° C. so that new SiC crystallites get dispersed in the molten silica nanopockets wherein they are recycled through equation (10), and eventually coalesce as SiO₂ is consumed with no gaps or crevices between them. This model is not unreasonable considering together that: (a) nanoparticulate matter melts at much lower temperatures than the bulk form; (b) silica aerogels undergo sintering (and therefore surface melting) at ˜1050° C.; and, (c) the reaction between silica and carbon takes place at the interface of the two materials. By the same line of reasoning, SiO₂ remains solid in samples processed at 1200° C. Consequently, amorphous SiC particles are not in full contact with SiO₂ or one another, and the SiC/SiO₂ mixtures are mesoporous with relatively high surface areas. According to this model, further heating of such samples above 1300° C. causes melting of SiO₂ and the terminal samples resume the appearance of samples processed at those temperatures from the beginning (see FIG. 9).

Methods of one-step synthesis of a PAN-crosslinked silica framework may be advantageous over previous works of polymer crosslinked aerogels where crosslinking agents are introduced post-gelation by solvent exchanges, which can be time-consuming. Embodiments of the overall process described herein may be effective for processes within a conformally coated silica framework. In some embodiments, methods for synthesizing PAN-crosslinked silica frameworks may involve post-crosslinking washes, but are not necessary requirements of that described herein. Where processes occur within a conformally coated skeletal framework, post-crosslinking removal of loose PAN may be circumvented where carbon formed in the mesopores may be removable at a final oxidation step. Since mechanically strong polymer crosslinked aerogels can be made through ambient pressure drying, SCF CO₂ drying might not be a necessary step in preparation of the final product.

SiC may retain a high mechanical strength and oxidation stability over 1500° C. Accordingly, SiC may provide an alternative to silica, alumina and carbon for use as a catalyst support. Preparation of monolithic porous SiC is usually elaborate and porosities around 30% v/v are typically considered high.

Polymer crosslinked interpenetrating resorcinol-formaldehyde (RF)/iron oxide nanoparticles may be used for the pyrolytic synthesis of iron aerogels. In this case, carbothermal reduction occurs between RF and iron oxide where a crosslinking polymer (e.g., polyurea) facilitates RF and iron oxide nanoparticles to come into better contact by melting, rendering their reaction more efficient. In this example, the onset of the reduction may be decreased by 400° C. relative to non-crosslinked samples. In embodiments provided herein, the crosslinking polymer (e.g., PAN) is the reagent and does not melt and the 3D core-shell structure is retained through aromatization, carbonization and carbothermal reduction. As a result, such methods described herein are efficient in the synthesis of highly porous (70%) monolithic SiC. In some embodiments, conformal PAN coatings may be obtained with other surface-confined initiators, including those initiators that are monodentate. Alternatively, in some embodiments, such coatings could also be obtained by engaging surface-confined acrylates via homogeneous thermal or photo-polymerization of AN in the mesopores.

Monolithic highly porous (70% v/v) SiC are synthesized by carbothermal reduction (e.g., at a temperature of 1200-1600° C.) of 3D sol-gel silica nanostructures (aerogels) conformally coated and crosslinked with polyacrylonitrile (PAN). Synthesis of PAN-crosslinked silica aerogels may be carried out in a single reaction vessel by simple mixing of the monomers, while conversion to SiC may be carried out in a tube reactor by programmed heating.

Intermediates after aromatization (e.g., at a temperature of 225° C. in air) and carbonization (e.g., at a temperature of 800° C. under Ar) may be isolated and characterized for their chemical composition and materials properties. Data may be interpreted mechanistically and the process may be iteratively optimized. Solids ²⁹Si NMR validates use of skeletal densities (by He pycnometry) for the quantification of the conversion of silica to SiC. Consistent with the topology of the carbothermal process. data support that complete conversion of SiO₂ to SiC requires a higher than stoichiometric C:SiO₂ ratio of 3.

As the morphology of the SiC network may be independent of the processing temperature between 1300° C. and 1600° C., it may be advantageous to carry out the carbothemal process at higher temperatures where reactions are able to run faster.

Samples may include pure polycrystalline β-SiC (skeletal density: 3.20 g cm⁻³) with surface areas in the range reported previously for biomorphic SiC (˜20 m² g-⁻¹). Although micromorphology may remain constant, the crystallite size of SiC may increase with the processing temperature (from 7.1 nm at 1300° C. to 16.5 nm at 1600° C.). Samples processed at 1200° C. may be amorphous (as determined by XRD), even though they may include ˜75% mol/mol SiC. As a result, a polymer crosslinked aerogel is used in the synthesis of another porous material.

Examples of Cross-Linking Agents Other than PAN

As discussed above, PAN is not a required cross-linking agent for use in embodiments of aerogels provided. Indeed, a number of suitable cross-linking agents may be used in forming a conformal coating on an aerogel network. Table 7, shown below, lists suitable crosslinkers that may be used to form a cross-linked aerogel.

TABLE 7
Carbonization data for various crosslinkers
upon pyrolysis at 800° C. under Ar.

| | residue yield | % w/w ^{b} | | |
|---|---|---|---|---|
| Crosslinker:^{a} | % w/w | C | H | N |
| Desmodur N3300A | 1.8 | | | |
| Desmodur N3200 | 3.2 | | | |
| Desmodur RE | 56 | 80.72 ± 0.79 | 0.0 | 8.59 ± 0.41 |
| Mondur CD (MDI) | 19 | 65.42 ± 0.20 | 0.0 | 4.97 ± 0.12 |
| Mondur TD (TDI) | 25 | 76.66 ± 1.01 | 0.0 | 8.40 ± 0.69 |

^{a}Data taken from pyrolysis of polyurea aerogels synthesized from crosslinkers listed. The aerogel serves a proxy for a porous, monolithic form of the crosslinker relevant for the present invention. Samples were synthesized using about 0.2M crosslinker in acetonitrile solutions with 3.0 mol equivalents of water and 0.6% w/w Et₃N.
^{b} All formulations run three times from samples from three different batches.

### Example of a SiC Aerogel Formed from a Silica Coated RE Isocyanate

The flowchart depicted below describes a process of synthesizing a SiC aerogel from a cross-linked aerogel where RE-isocyanate conformally coats a silica sol-gel material:

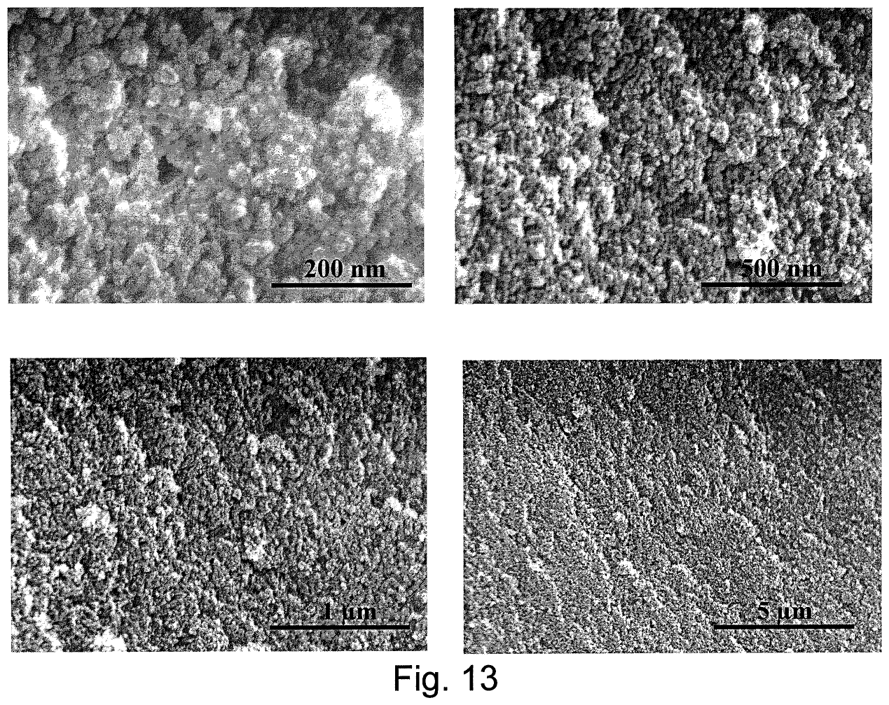

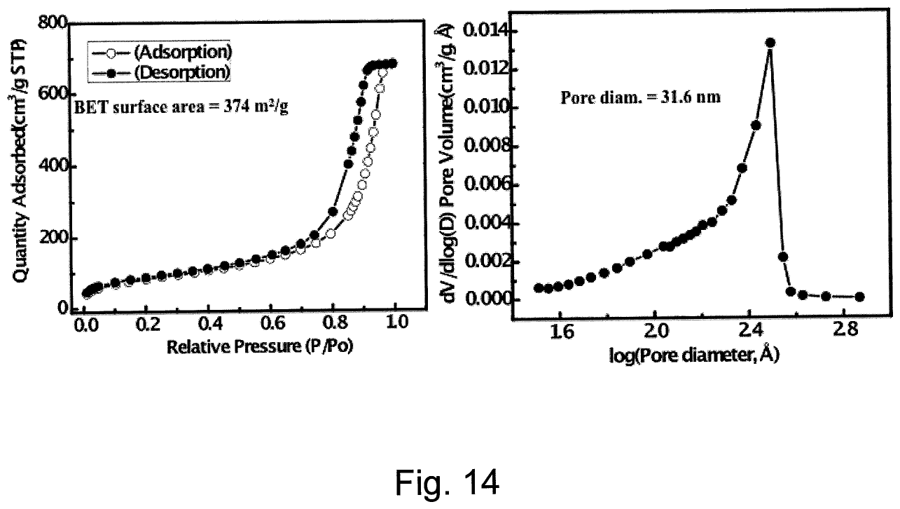

A nanoporous silica sol-gel network is formed from a variety of precursors, namely TMOS, APTES, CH₃CN and H₂O. A RE-isocyanate cross-linking agent is applied to surfaces of the nanoporous silica sol-gel to form a conformal coating on the sol-gel. A cross-linked silica aerogel including a conformal coating of RE-isocyanate is then formed after supercritical drying with CO₂, examples of the surface of which is shown in FIG. 13. Nitrogen sorption isotherms as shown in FIG. 14 provide physical characteristics, such as surface area and pore size, of the cross-linked silica aerogel RE at room temperature.

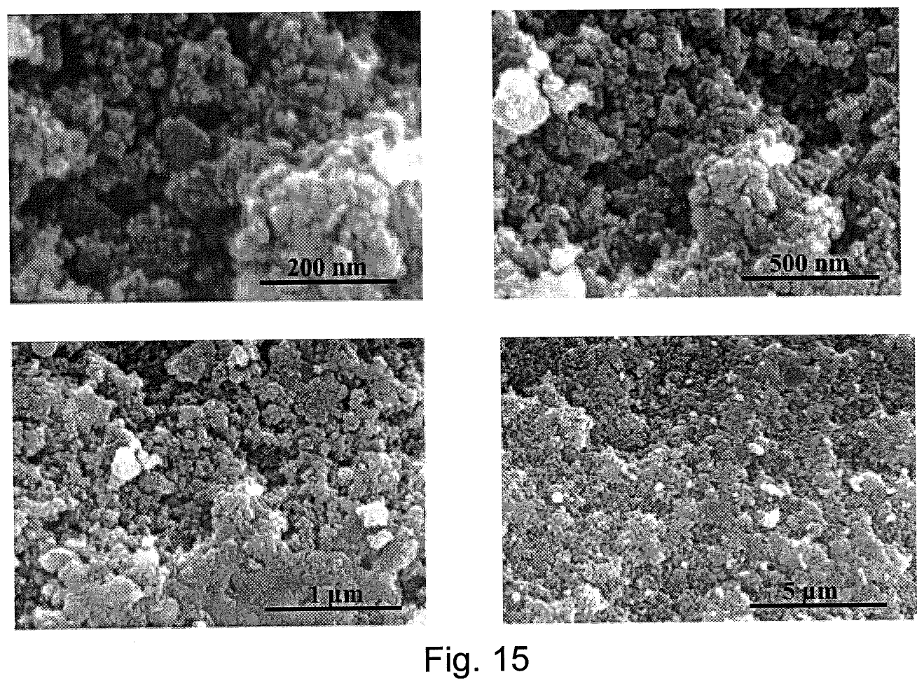

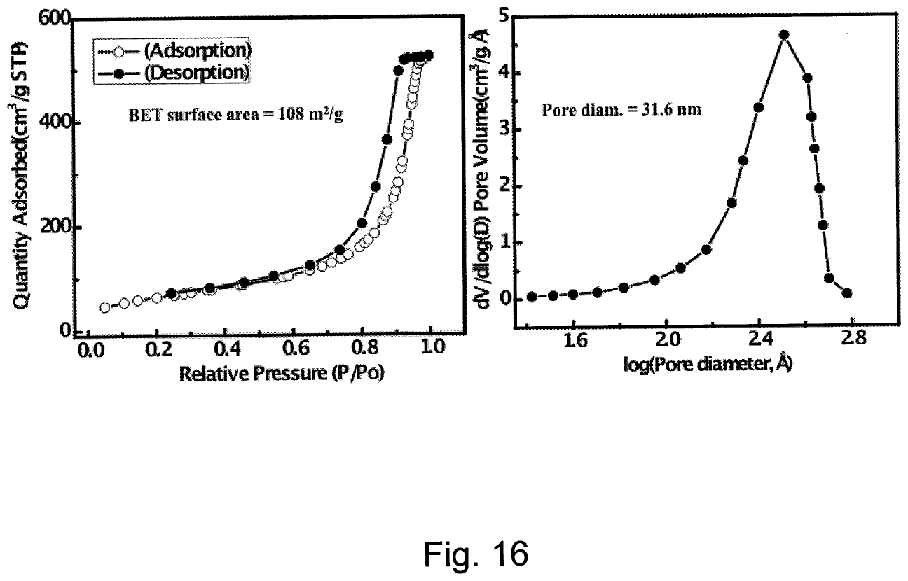

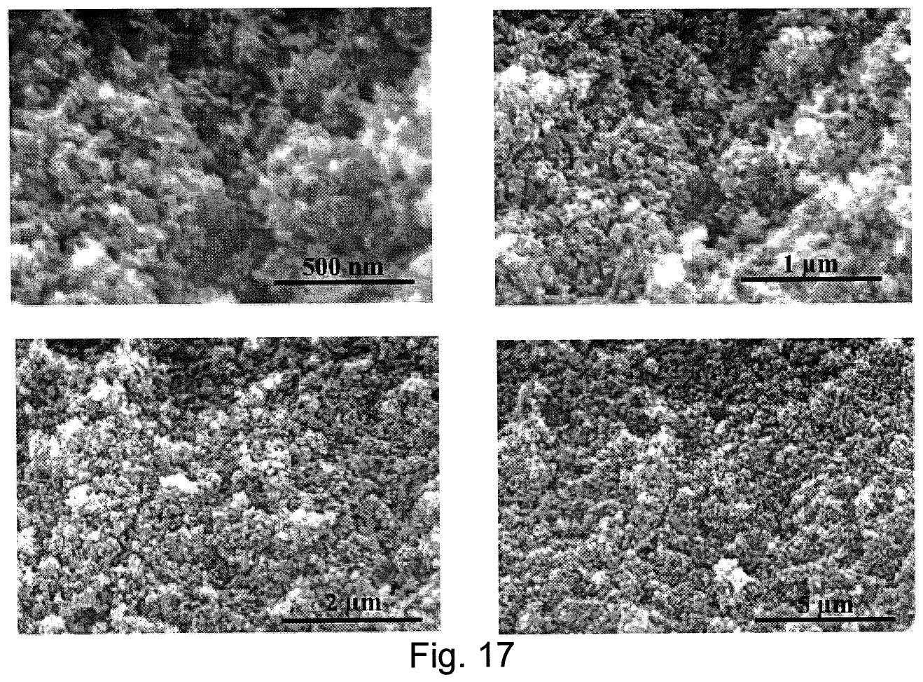

The cross-linked silica RE aerogel is then subjected to carbothermal reduction treatment in an inert atmosphere at 1500 C for 36 hours, yielding a carbon-coated SiC aerogel. Prior to pyrolysis, the mass of the sample was measured to be 0.6158 g. After pyrolysis under an Ar atmosphere at 800 C, the mass of the sample was measured to be 0.4309 g. SEM micrographs of the aerogel as provided in FIG. 17 show residual carbon left on the surface of the aerogel after pyrolysis under an Ar atmosphere at 800 C. The nitrogen sorption isotherms depicted in FIG. 16 show a decrease in surface area after pyrolyzing the cross-linked silica aerogel RE at 800 C. FIG. 15 illustrate SEM micrographs of the aerogel after pyrolysis under an Ar atmosphere at 1500 C also showing unreacted carbon residue left on the surface of the aerogel material.

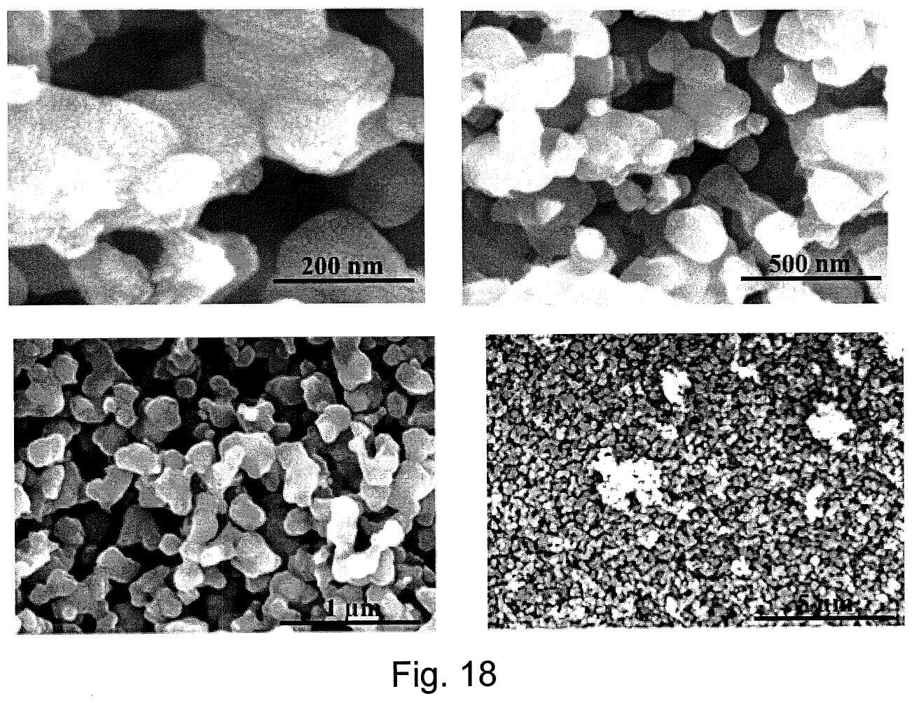

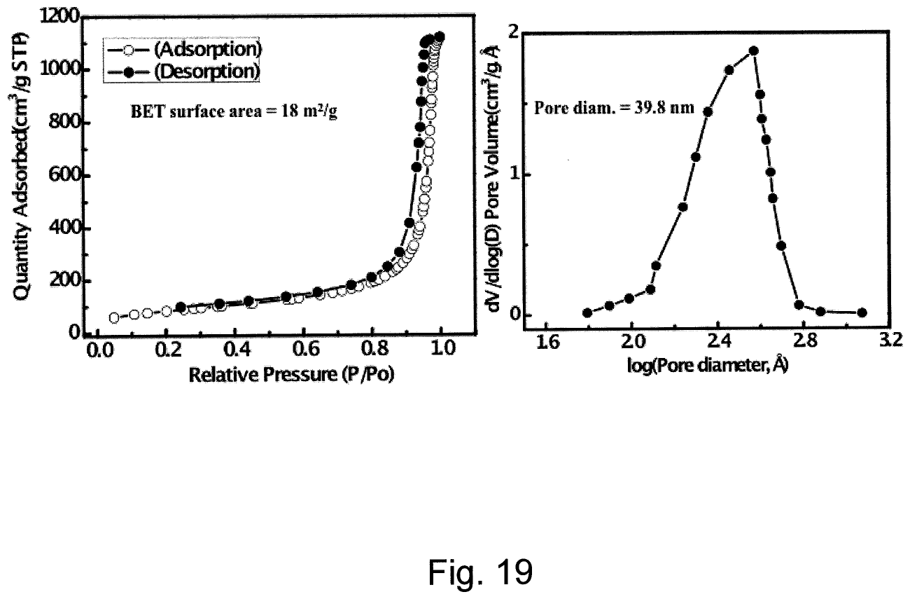

The unreacted carbon is removed from the SiC aerogel via a step of oxidation and heating. SEM micrographs and nitrogen sorption isotherms of the cleaned SiC aerogel surface shown in FIGS. 18 and 19, respectively, indicate the surface area to generally be decreased and the average pore size to be increased. Once carbon is removed in air at 800 C, the mass of the sample (SiC) was measured to be 0.1806 g. XRD data for the sample having undergone pyrolysis at 1500 C indicate the chemical make up of the nanoporous network to be crystalline SiC. Table 8 lists a number of structural properties of the cross-linked silica RE aerogel before and after pyrolysis.

Examples of Metal and Metal Carbide Aerogels

The following flowchart summarizes preparation of metal and metal carbide aerogels from a cross-linked metallic aerogel having a conformal coating of triphenylmethane-4,4′,4″-triisocyanate (TMT, chemical structure shown below), where “MCl₃” stands for a metal chloride and “X-” stands for a cross-linked sample:

A wet nanoporous metal oxide sol-gel network is formed from hydrated metal chloride and epichlorohydrin. TMT is applied as a cross-linking agent to the wet gel to form a suitable conformal coating on the metal oxide sol-gel material. After a step of supercritical drying with CO₂, a cross-linked metal oxide aerogel having a TMT coating is formed. Alternatively, in accordance with the example flowchart provided above, RE isocyanate may be used as a cross-linking agent in place of TMT. In addition, a number of metal oxides may be suitably provided to form the three-dimensional nanoporous network. The cross-linked metal oxide aerogel may be subject to suitable steps of pyrolysis, including carbothermal reduction, to yield a metal aerogel and/or a metal carbide aerogel. As described above, whether a metal aerogel or a metal carbide aerogel is produced may depend on how heavily the aerogel is carbon-coated. For instance, for a carbon coating having a substantial amount of carbon, a metal carbide aerogel may result. Alternatively, for a carbon coating having a minimal amount of carbon, a metal aerogel may be produced.

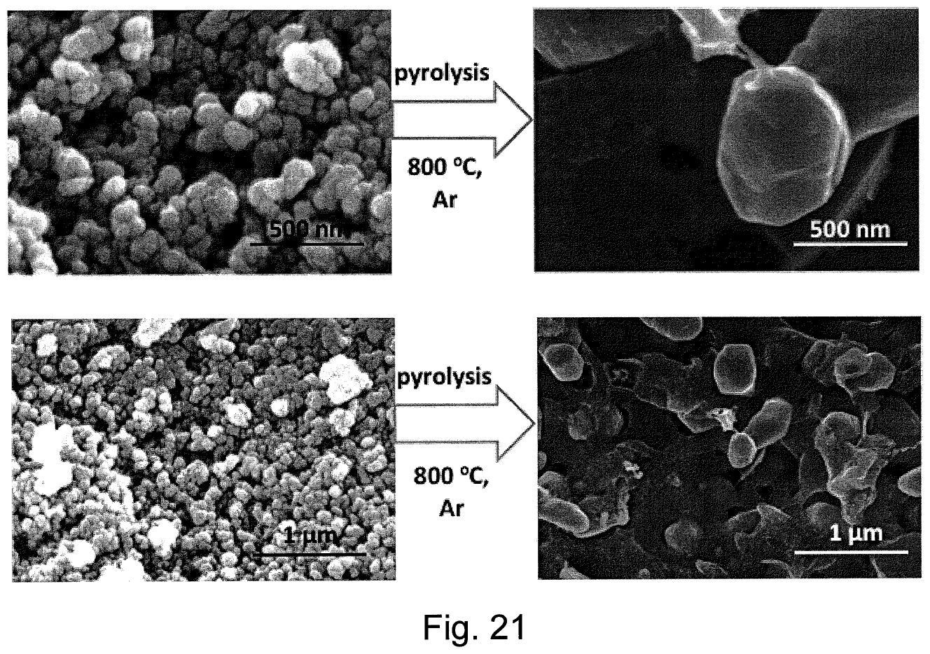

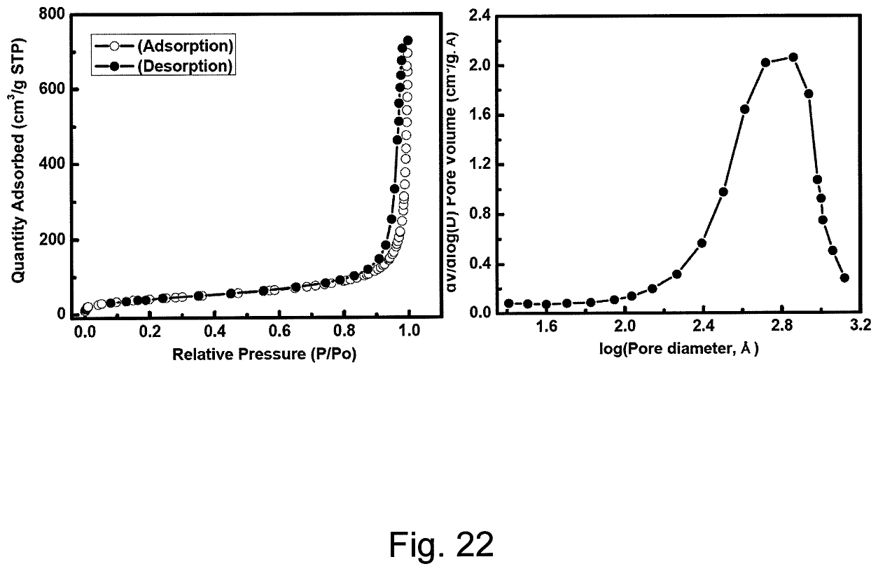

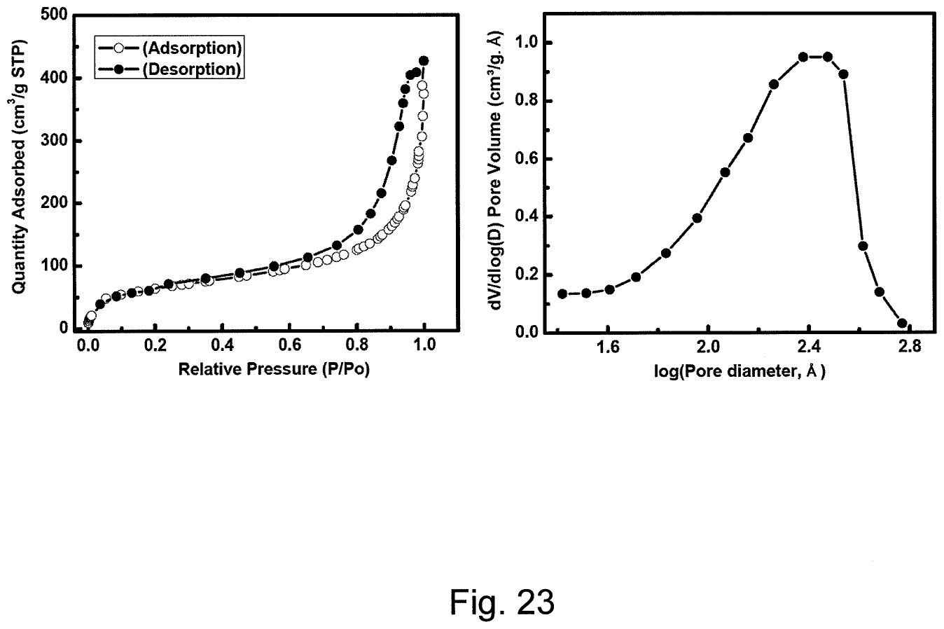

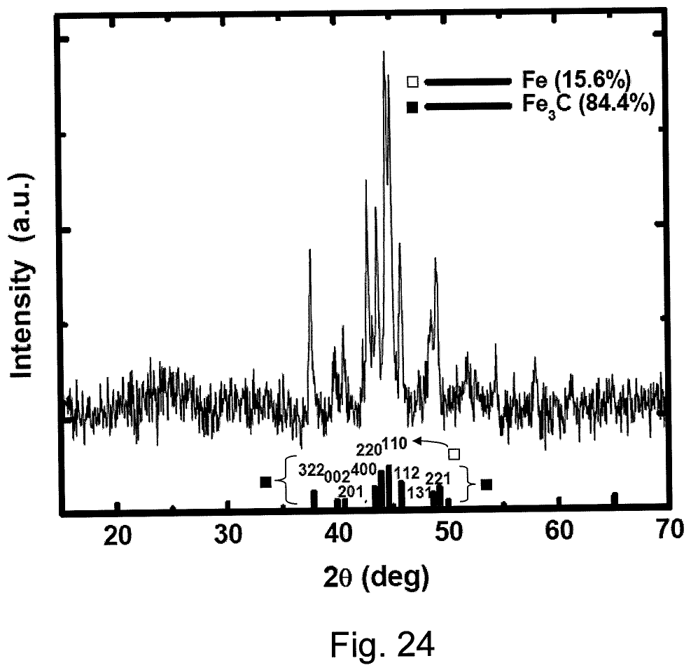

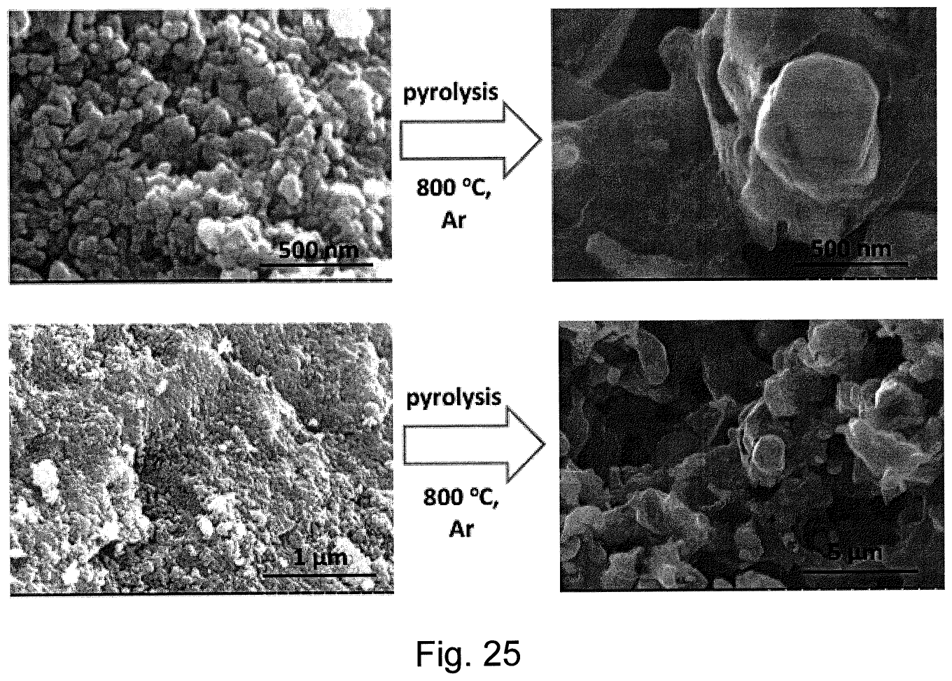

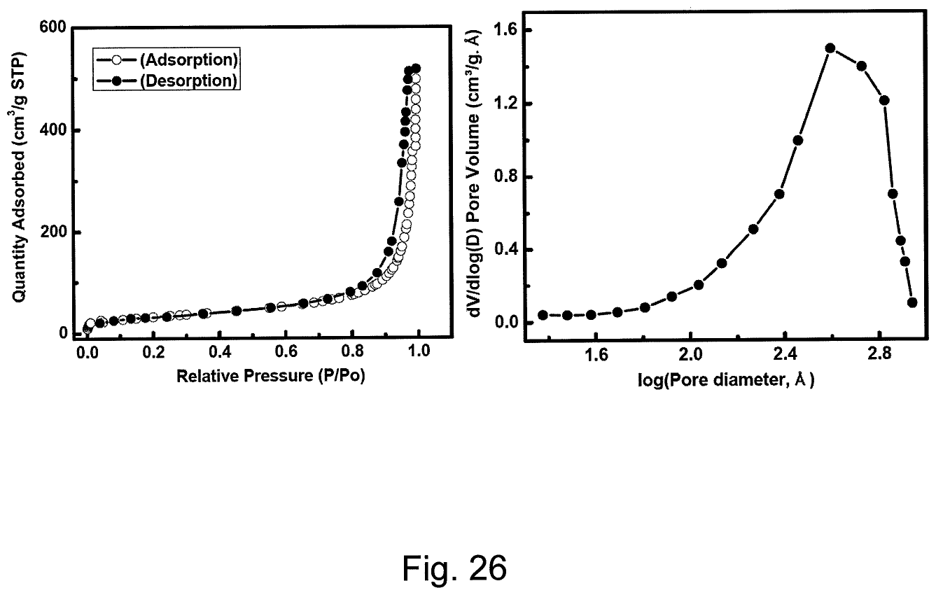

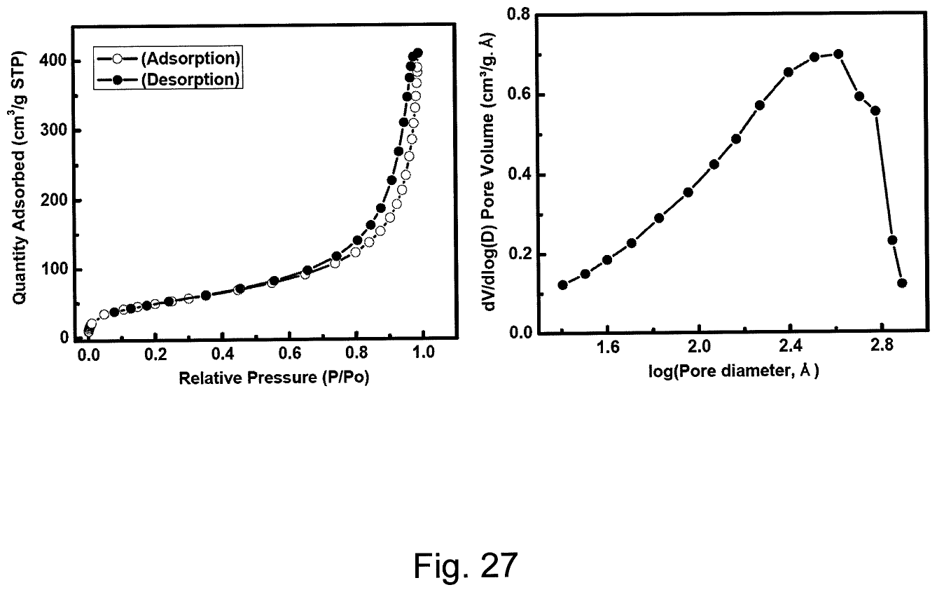

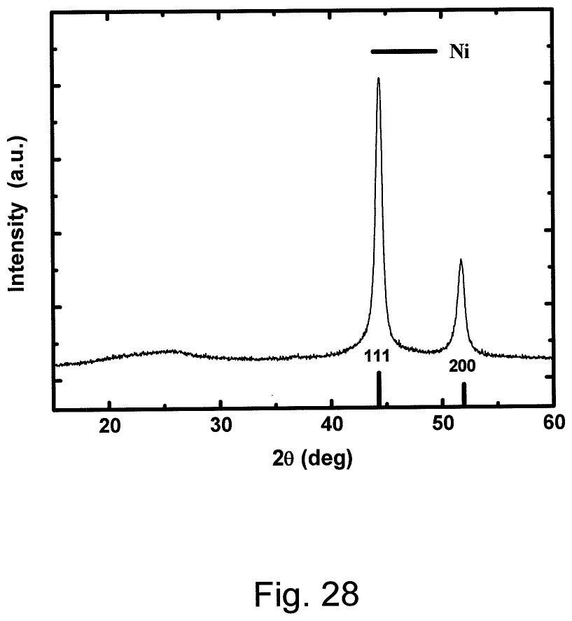

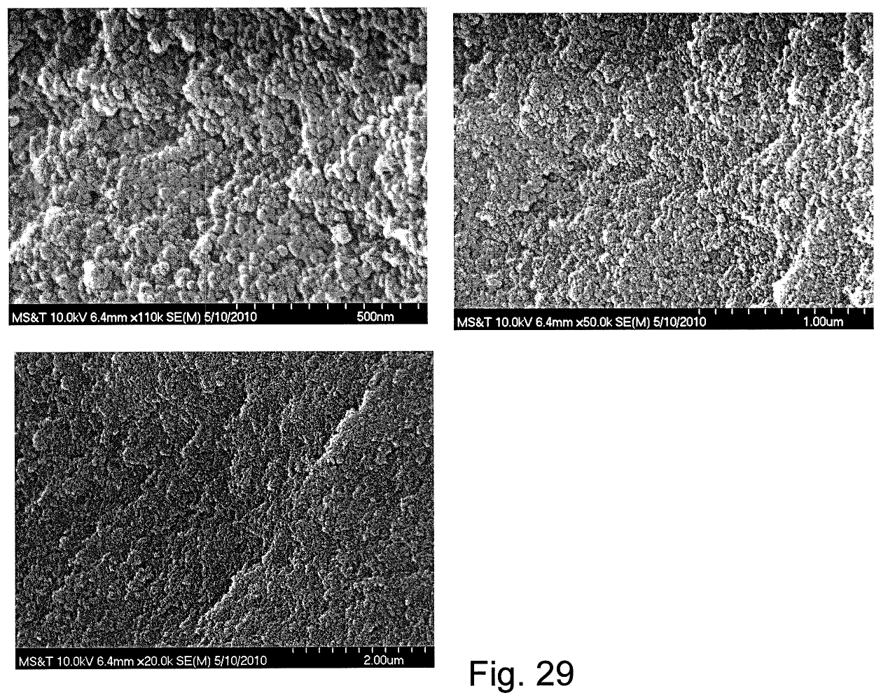

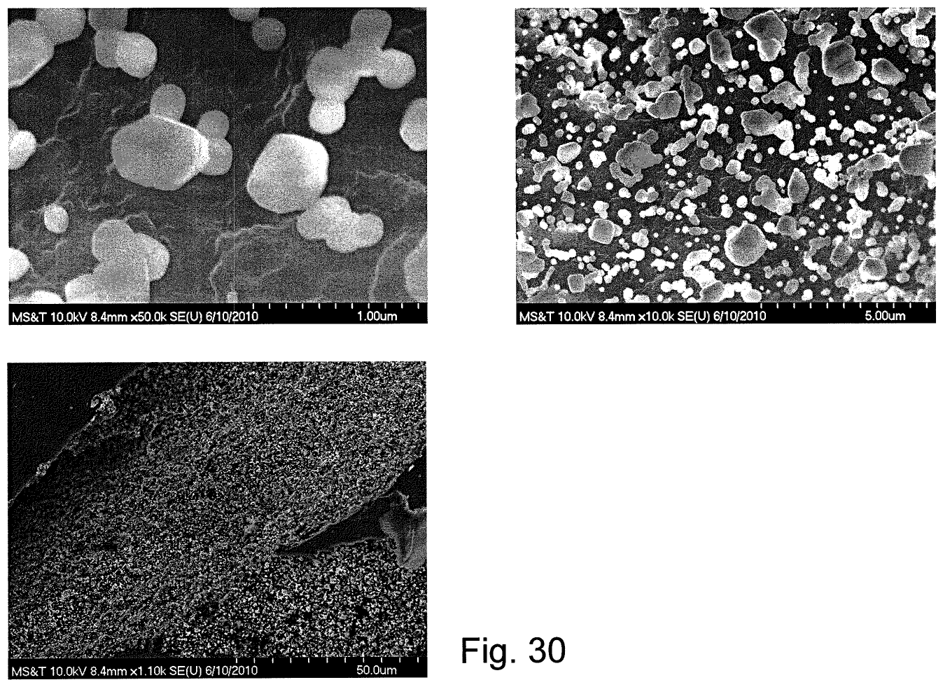

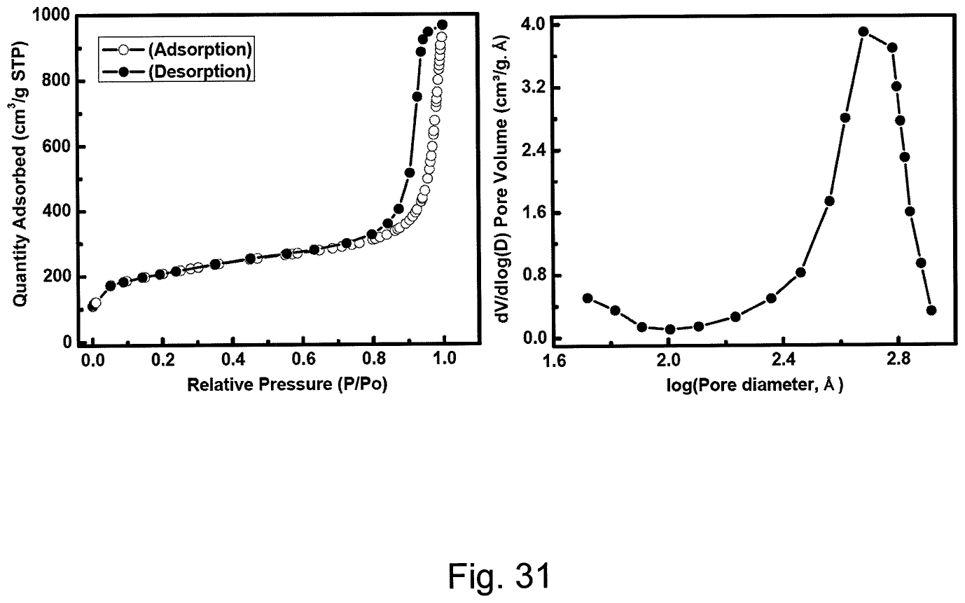

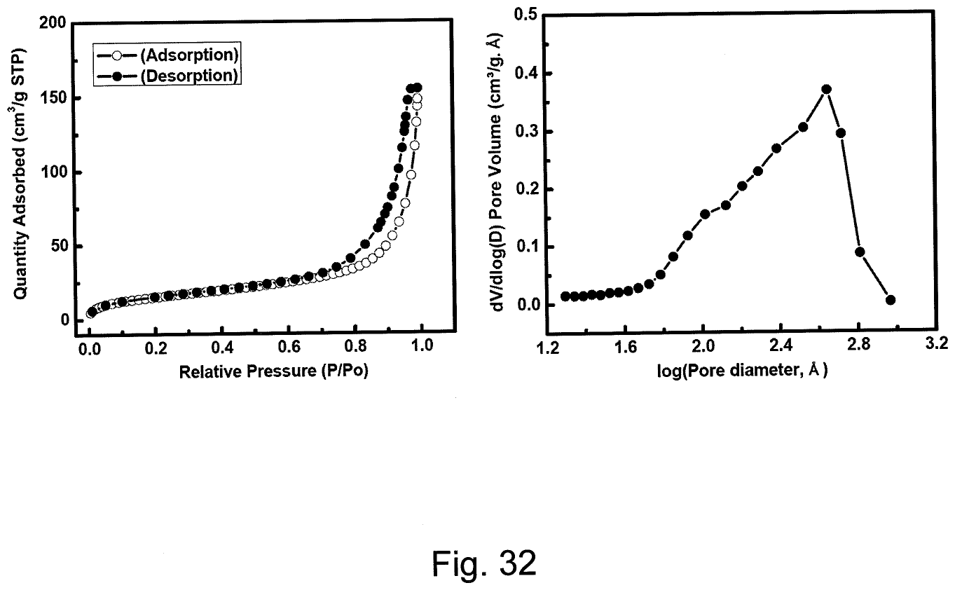

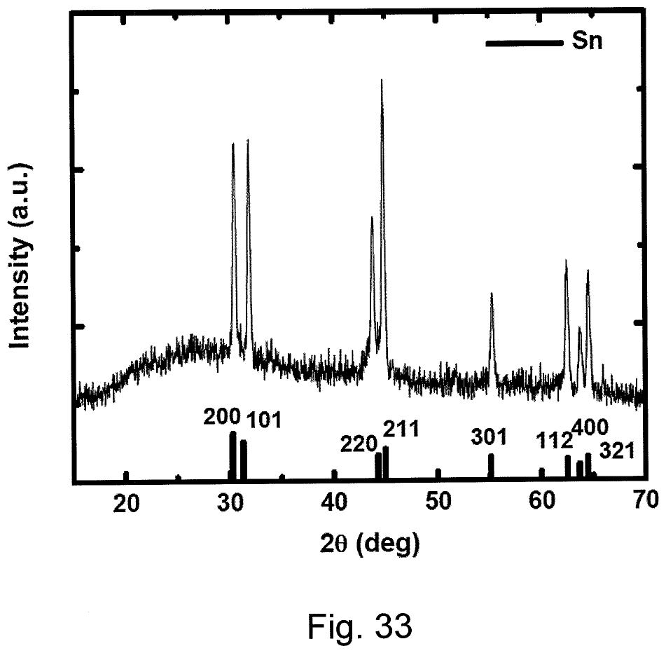

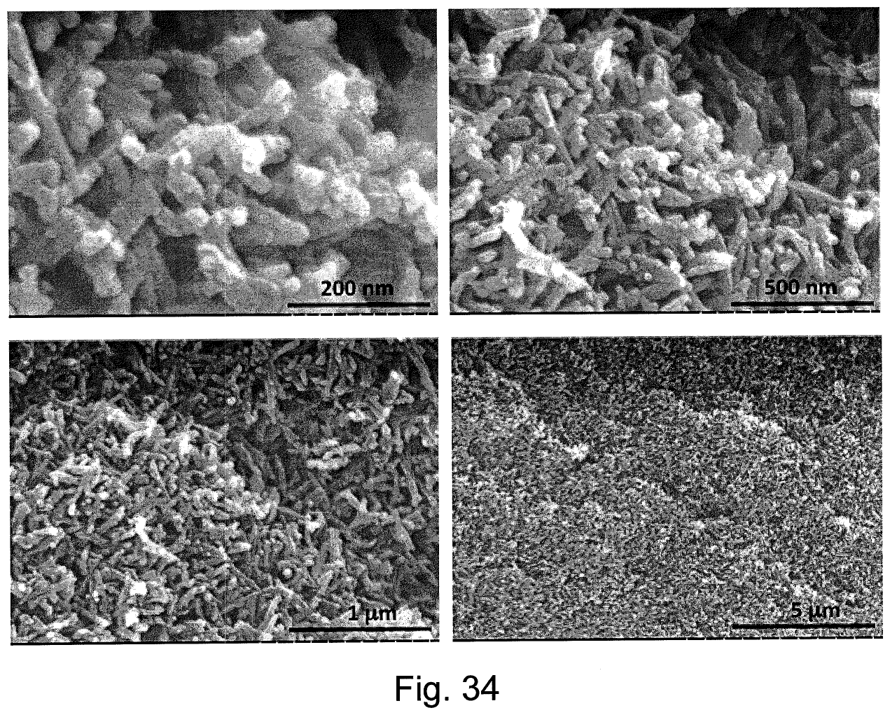

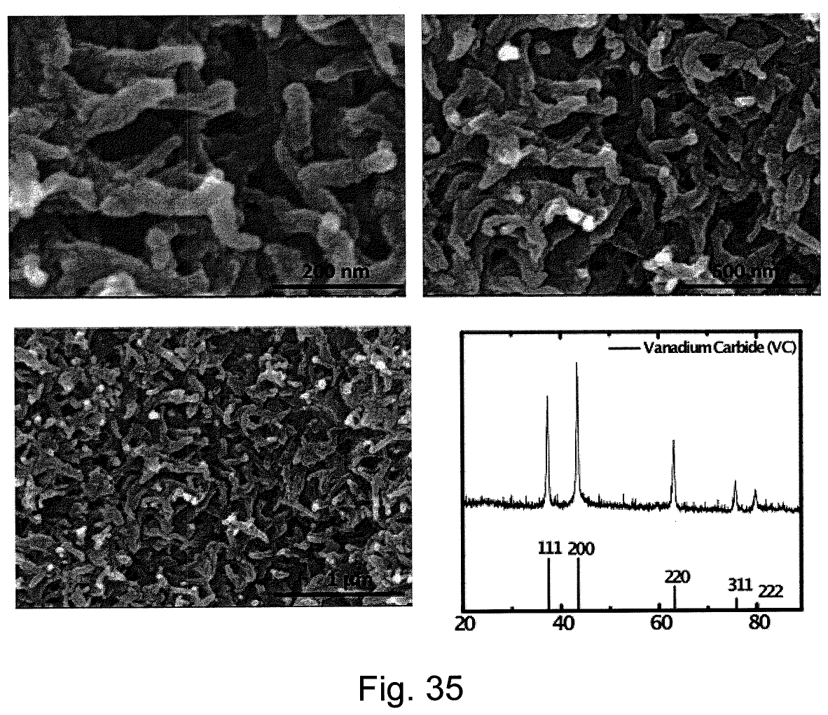

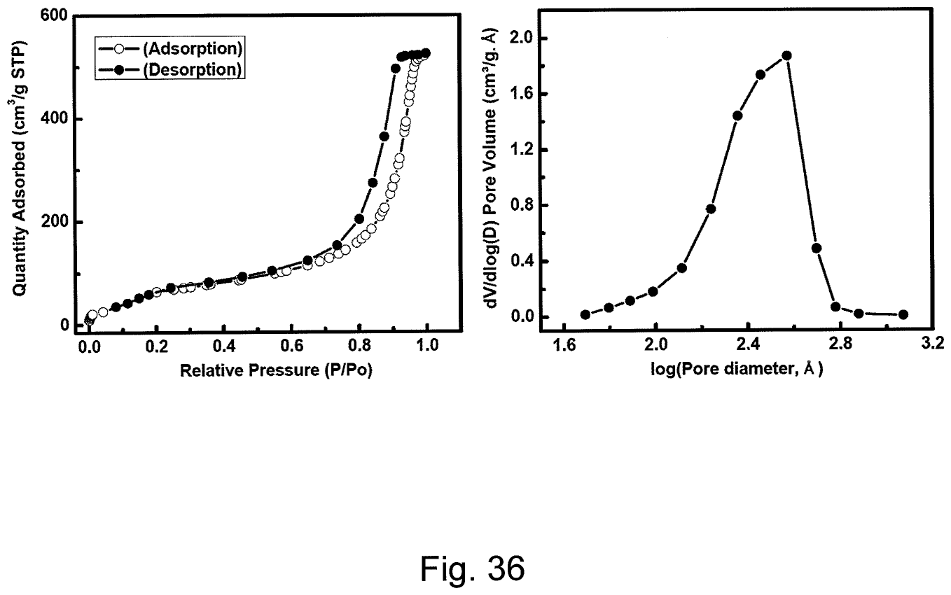

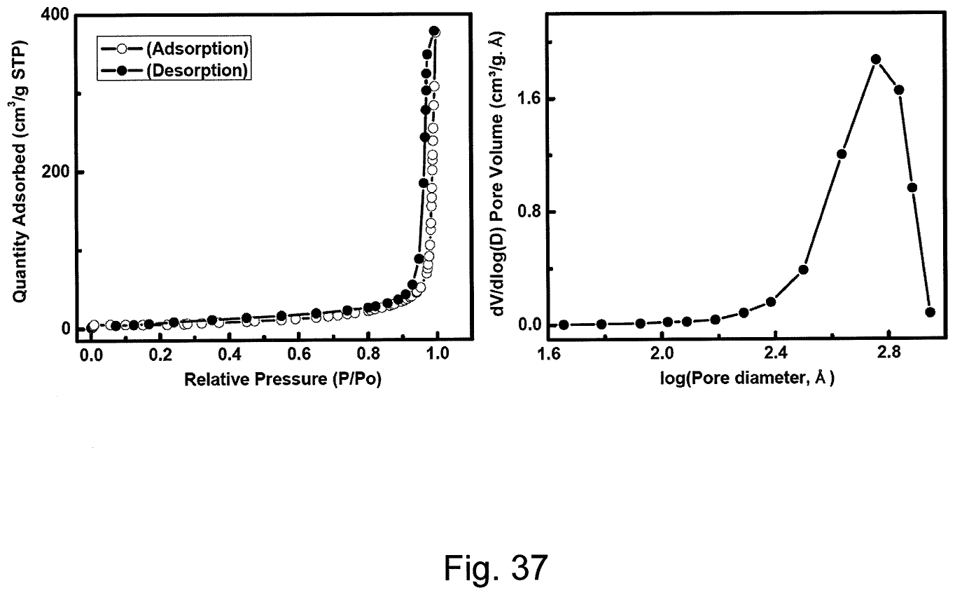

Data for metal aerogels and metal carbide aerogels produced from a number of different types of cross-linked metal oxide aerogels are provided herein. Cross-linked metal oxide aerogels are produced from iron oxide, tin oxide, nickel oxide and vanadium oxide. FIGS. 21-24 show SEM micrographs, nitrogen sorption isotherms and XRD data resulting from cross-linked iron oxide aerogels having been processed before and after pyrolysis under an Ar atmosphere at 800 C. In addition, FIGS. 25-28 depict SEM micrographs, nitrogen sorption isotherms and XRD data measured from cross-linked nickel oxide aerogels having been processed before and after pyrolysis under an Ar atmosphere at 800 C. Further, SEM images, nitrogen sorption isotherms and XRD data are illustrated in FIGS. 29-33 for cross-linked tin oxide aerogel having been processed before and after pyrolysis under an Ar atmosphere at 800 C. Lastly, SEM images, nitrogen sorption isotherms and XRD data are depicted in FIGS. 34-37 for cross-linked vanadium oxide aerogel having been processed before and after pyrolysis under an Ar atmosphere at 800 C. Table 9 lists a number of structural properties of the cross-linked metal oxide aerogels (i.e., iron oxide, nickel oxide, tin oxide and vanadium oxide) before and after pyrolysis. After suitable pyrolysis, corresponding metal aerogels and/or metal carbide aerogels are produced.

TABLE 8
Selected Properties of (X-SiO₂-RE) aerogels before and after pyrolysis at different temperatures.

| | | | | | | | | |
|---|---|---|---|---|---|---|---|---|
| | | | | skeletal | porosity, | BET surface | average | particle |
| | diameter | shrinkage | bulk density, | density, | II (% void | area, σ | pore | radius, |
| sample | (cm) ^{a} | (%) ^{a, b} | ρ_{b} (g cm⁻³) ^{a} | ρₛ (g cm⁻³) ^{c} | space) | (m² g⁻¹) | diameter (nm) ^{d} | r (nm) ^{e} |

X-SiO₂-RE

| | | | | | | | |
|---|---|---|---|---|---|---|---|
| 0.91 ± 0.08 | 12.5 ± 0.12 | 0.56 ± 0.04 | 2.14 ± 0.25 | 73.7 | 368 | 25.8 [14.2](31.6) | 3.80 |

X-SiO₂-RE after pyrolysis at 800° C.

| | | | | | | | |
|---|---|---|---|---|---|---|---|
| 0.78 ± 0.05 | 18.2 ± 0.36 | 0.35 ± 0.07 | 2.45 ± 0.15 | 85.7 | 108 | 90.7 [15.1](31.8) | 11.3 |

X-SiO₂-RE after pyrolysis at 1500° C. for 36 h after removing carbon

| | | | | | | | |
|---|---|---|---|---|---|---|---|
| 0.49 ± 0.25 | 45.2 ± 1.28 | 0.49 ± 0.18 | 3.11 ± 0.14 | 84.3 | 22 | 312[15.0](39.8) | 43.8 |

^{a} Average of 3 samples. (Mold diameter: 1.04 cm.)
^{b} Shrinkage = 100 × (sample diameter − mold diameter)/(mold diameter).
^{c} Single sample, average of 50 measurements.
^{d} By the 4 × V_{Total}/σ method. For the first number, V_{Total} was calculated by the single-point adsorption method; for the number in brackets V_{Total} was calculated via V_{Total} = (1/ρ_{b}) − (1/ρₛ).
^{e} Calculated via r = 3/ρₛσ.

TABLE 9
Selected properties of X-MOx-RE aerogels before and after pyrolysis at 800° C.

| | | | | | | | | |
|---|---|---|---|---|---|---|---|---|
| | | | | skeletal | porosity, | BET surface | average | particle |
| | diameter | shrinkage | bulk density, | density, | II (% void | area, σ | pore | radius, |
| sample | (cm) ^{a} | (%) ^{a, b} | ρ_{b} (g cm⁻³) ^{a} | ρₛ (g cm⁻³) ^{c} | space) | (m² g⁻¹) | diameter (nm) ^{d} | r (nm) ^{e} |

X-FeOx-RE at RT

| | | | | | | | |
|---|---|---|---|---|---|---|---|
| 0.925 ± 0.017 | 7.5 ± 0.8 | 0.41 ± 0.02 | 1.82 ± 0.018 | 77.4 | 141.76 | 15.5(29.7)[51.2] | 8.67 |

X-FeOx-RE after pyrolysis at 800° C.

| | | | | | | | |
|---|---|---|---|---|---|---|---|
| 0.541 ± 0.008 | 41.5 ± 1.2 | 0.19 ± 0.03 | 5.68 ± 0.12 | 96.6 | 118.44 | 5.91(24.1)[29.5] | 2.62 |

X-NiOx-RE at RT

| | | | | | | | |
|---|---|---|---|---|---|---|---|
| 0.932 ± 0.014 | 6.8 ± 0.7 | 0.38 ± 0.01 | 1.48 ± 0.018 | 74.3 | 58.95 | 45.8(12.8)[39.7] | 19.33 |

X-NiOx-RE after pyrolysis at 800° C.

| | | | | | | | |
|---|---|---|---|---|---|---|---|
| 0.431 ± 0.006 | 53.7 ± 1.8 | 0.36 ± 0.07 | 3.37 ± 0.04 | 89.3 | 171.98 | 6.9(12.1)[41.6] | 6.27 |

X-SnOx-RE at RT

| | | | | | | | |
|---|---|---|---|---|---|---|---|
| 0.953 ± 0.021 | 4.7 ± 0.2 | 0.43 ± 0.014 | 1.73 ± 0.01 | 75.1 | 111.58 | 20.72(14.2)[47.8] | 11.56 |

X-SnOx-RE after pyrolysis at 800° C.

| | | | | | | | |
|---|---|---|---|---|---|---|---|
| 0.524 ± 0.008 | 45.0 ± 1.1 | 39 ± 0.03 | 2.67 ± 0.09 | 84.2 | 128.3 | 11.67(12.9)[43.6] | 9.82 |

X-VOx-RE at RT

| | | | | | | | |
|---|---|---|---|---|---|---|---|
| 0.974 ± 0.008 | 6.3 ± 0.8 | 0.39 ± 0.014 | 1.37 ± 0.01 | 71.5 | 270.8 | 10.7(12.4)[37.1] | 4.32 |

X-VOx-RE after pyrolysis at 800° C.

| | | | | | | | |
|---|---|---|---|---|---|---|---|
| 0.623 ± 0.015 | 36.0 ± 1.5 | 0.64 ± 0.13 | 3.24 ± 0.02 | 80.2 | 20.1 | 61.4(41.4)[56.2] | 95.52 |

Average of 3 samples. (Mold diameter: 1.04 cm.)
^{b} Shrinkage = 100 × (sample diameter − mold diameter)/(mold diameter).
^{c} Single sample, average of 50 measurements.
^{d} By the 4 × V_{Total}/σ method. For the first number, V_{Total} was calculated by the single-point adsorption method; for the number in brackets V_{Total} was calculated via V_{Total} = (1/ρ_{b}) − (1/ρₛ).
^{e} Calculated via r = 3/ρₛσ.

Having thus described several aspects of at least one embodiment of this invention, it is to be appreciated various alterations, modifications, and improvements will readily occur to those skilled in the art. Such alterations, modification, and improvements are intended to be part of this disclosure, and are intended to be within the spirit and scope of the invention. Accordingly, the foregoing description and drawings are by way of example only.

What is claimed is:

1-66. (canceled)

67. An electrode, comprising:
an aerogel, comprising:
carbon, and
elemental silicon.

68. The electrode of claim 67, wherein the electrode further comprises silicon carbide.

69. The electrode of claim 68, wherein the silicon carbide comprises silicon carbide particles.

70. The electrode of claim 67, wherein the aerogel comprises silicon particles.

71. A battery comprising the electrode of claim 67.

72. A capacitor comprising the electrode of claim 67.
